(19) United States
(12) Patent Application Publication
(10) Pub. No.: US 2026/0222884 A1
(43) Pub. Date: Jul. 30, 2026

(54) COMMUNICATION METHOD, USER EQUIPMENT, AND NETWORK NODE

(71) Applicant: Samsung Electronics Co., Ltd., Suwon-si (KR)

(72) Inventors: Dan LIU, Beijing (CN); Yuanyuan ZHANG, Beijing (CN); Yanze FU, Beijing (CN); He WANG, Beijing (CN); Jiseon KANG, Suwon-si (KR); Bozhi LI, Beijing (CN)

(21) Appl. No.: 19/457,945

(22) Filed: Jan. 23, 2026

Related U.S. Application Data
(63) Continuation of application No. PCT/KR2026/095035, filed on Jan. 22, 2026.

(30) Foreign Application Priority Data
Jan. 26, 2025 (CN) 202510125627.8
Dec. 17, 2025 (CN) 202511916352.6

(51) Int. Cl. H04W 24/10; H04B 17/318; H04L 5/00; H04W 8/22; H04W 56/00; H04W 76/28

(52) U.S. Cl. CPC H04W 24/10; H04B 17/328; H04L 5/0041; H04W 8/22; H04W 56/0015; H04W 76/28

(57) ABSTRACT

A method performed by a user equipment (UE) in a communication system is provided. The method includes receiving measurement configuration information, the measurement configuration information including information related to measurements of a first carrier, a second carrier, and a third carrier, measuring the first carrier and the second carrier based on the measurement configuration information to obtain a first measurement result, and determining a measurement period for the third carrier based on the first measurement result, and measuring the third carrier based on the measurement period.

### CROSS-REFERENCE TO RELATED APPLICATION(S)

This application is a continuation application, claiming priority under 35 U.S.C. § 365(c), of an International application No. PCT/KR2026/095035, filed on Jan. 22, 2026, which is based on and claims the benefit of a Chinese patent application number 202510125627.8, filed on Jan. 26, 2025, in the Chinese Intellectual Property Office, and of a Chinese patent application number 202511916352.6, filed on Dec. 17, 2025, in the Chinese Intellectual Property Office, the disclosure of each of which is incorporated by reference herein in its entirety.

### TECHNICAL FIELD

The disclosure relates to a technical field of wireless communications. More particularly, the disclosure relates to a communication method, a user equipment (UE), and a network node.

### BACKGROUND

In order to meet the increasing demand for wireless data communication services since the deployment of fourth generation (4G) communication systems, efforts have been made to develop improved fifth generation (5G) or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter wave (mmWave)) bands, e.g., 60 gigahertz (GHz) bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid frequency shift keying (FSK) and quadrature amplitude modulation (QAM) (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method to optimize the measurement requirements of at least two non-contiguous serving carriers based on different radio frequency (RF) receiving modes.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving measurement configuration information, the measurement configuration information including information related to measurements of a first carrier, a second carrier, and a third carrier, obtaining a first measurement result by measuring the first carrier and the second carrier based on the measurement configuration information, and determining a measurement period for the third carrier based on the first measurement result, and obtaining a second measurement result by measuring the third carrier based on the measurement period.

Optionally, the first carrier and the second carrier are non-contiguous carriers.

Optionally, the UE supports a first capability that includes a capability of using a first receiving mode to receive the first carrier and the second carrier, and the method further includes determining, based on at least one of the first measurement result, a second measurement result of measuring the third carrier and a switching condition, whether to switch from the first receiving mode to a second receiving mode to receive the first carrier and the second carrier, or whether to use the first receiving mode to receive a primary component carrier in the first carrier and the second carrier.

Optionally, the determining a measurement period for the third carrier includes at least one of determining a first measurement period for the third carrier based on a first scaling factor, when the first measurement result is larger than a first threshold, determining a second measurement period for the third carrier based on at least one of an interference received signal strength indication (RSSI) measurement timing configuration (RMTC) period, a discontinuous reception (DRX) cycle, a measurement in-gap carrier specific scaling factor (CSSF) and a measurement gap period of the third carrier, when the first measurement result is smaller than a second threshold, wherein the second measurement period is related to RSSI measurements, determining a third measurement period for the third carrier based on at least one of a period of reference signals transmitted on downlink carriers in different bands and the number of samples required for reference signal received power (RSRP) measurement of the third carrier in different bands, when the first measurement result is smaller than the second threshold, and determining a fourth measurement period for the third carrier based on at least one of the total number of samples to be measured, a period of reference signals transmitted on the third carrier, a second scaling factor related to Layer 1 and/or Layer 3 measurements and a measurement period lower bound related to UE capabilities, when the first measurement result is smaller than the second threshold, wherein the first scaling factor and the second scaling factor are measurement relaxation factors.

Optionally, measuring the third carrier based on the fourth measurement period includes determining a measurement window based on the fourth measurement period and a measurement result reporting configuration period, and performing the RSRP measurement on the third carrier in the measurement window.

Optionally, the method further includes normalizing a measurement result of measuring the third carrier based on the second measurement period, according to at least one of a default measurement bandwidth used for measurement, and the number of frequency-domain units, and reporting the normalized measurement result.

Optionally, the CSSF is determined based on at least one of the number of searchers related to band combinations of the first carrier and the second carrier, the proportion of resources occupied by each measured component carrier in the searchers, and the priority of each measured component carrier.

Optionally, when measuring the third carrier based on the first measurement period, the method further includes performing a synchronization signal block (SSB)-less based measurement or an SSB based measurement for a secondary component carrier in the first carrier and the second carrier.

Optionally, the method further includes determining a fifth measurement period for measurement of the first carrier and the second carrier based on the number of reference signal occasions unavailable for measurement in the measurement period, when the first measurement result is smaller than a second threshold, wherein the number of reference signal occasions unavailable for measurement in the measurement period includes at least one of the number of synchronization signal block (SSB) measurement timing configuration (SMTC) occasions unavailable for synchronization signal measurement in the measurement period and the number of SSB occasions unavailable for Layer 1 measurement in the measurement period.

Optionally, the number of reference signal occasions unavailable for measurement is related to at least one of a discontinuous reception (DRX) cycle and a reference signal period.

Optionally, the switching condition is related to at least one of first carrier aggregation reconfiguration information being received, and the first measurement result being smaller than a third threshold in a first evaluation duration, and the second measurement result of measuring the third carrier being larger than a fourth threshold in a second evaluation duration, wherein the first evaluation duration and the second evaluation duration are values configured by a network node or predefined.

Optionally, when the RSRP measurement results of the first carrier and the second carrier are smaller than the third threshold in the first evaluation duration, the third threshold is related to an RSRP threshold, and when the downlink received signal to interference plus noise ratio (SINR) performance of the first carrier and the second carrier is smaller than the third threshold in the first evaluation duration, the third threshold is related to a radio link monitor out-of-sync threshold.

Optionally, the method further includes switching from the first receiving mode to the second receiving mode to receive the first carrier and the second carrier after a first interruption length, when the switching condition is met.

Optionally, the method further includes sending, to a network node, UE assistance information (UAI) used for at least requesting the network node to reconfigure carrier aggregation, receiving second carrier aggregation reconfiguration information from the network node, and switching, based on the second carrier aggregation reconfiguration information, from the first receiving mode to the second receiving mode to receive the first carrier and the second carrier.

Optionally, after switching to the second receiving mode, the method further includes receiving third carrier aggregation reconfiguration information, and switching, based on the third carrier aggregation reconfiguration information, from the second receiving mode to the first receiving mode to receive the first carrier and the second carrier.

Optionally, the method further includes reporting, to a network node, information related to the first capability.

Optionally, the information related to the first capability includes at least one of an RF requirement related to band combinations of the first carrier and the second carrier, a radio resource management (RRM) requirement related to band combinations of the first carrier and the second carrier, and information related to a frequency span of the first carrier and the second carrier.

In accordance with an aspect of the disclosure, a method performed by a network node in a communication system is provided. The method includes sending measurement configuration information to a user equipment (UE), the measurement configuration information including information related to measurements of a first carrier, a second carrier, and a third carrier, and receiving a first measurement result and a second measurement result, the first measurement result being obtained by measuring the first carrier and the second carrier based on the measurement configuration information by the UE, the second measurement result being obtained by measuring the third carrier based on a measurement period for the third carrier by the UE, the measurement period being determined based on the first measurement result by the UE.

In accordance with an aspect of the disclosure, a user equipment (UE) in a communication system is provided. The UE includes a transceiver, memory, comprising one or more storage media, storing instructions, and at least one processor communicatively coupled to the transceiver and the memory, wherein the instructions, when executed by the at least one processor individually or collectively, cause the UE to receive measurement configuration information, the measurement configuration information comprising information related to measurements of a first carrier, a second carrier, and a third carrier, obtain a first measurement result by measure the first carrier and the second carrier based on the measurement configuration information, and determine a measurement period for the third carrier based on the first measurement result, and obtain a second measurement result by measure the third carrier based on the measurement period.

In accordance with an aspect of the disclosure, a network node in a communication system is provided. The network node includes a transceiver, memory, comprising one or more storage media, storing instructions, and at least one processor communicatively coupled to the transceiver and the memory, wherein the instructions, when executed by the at least one processor individually or collectively, cause the network node to send measurement configuration information to a user equipment (UE), the measurement configuration information comprising information related to measurements of a first carrier, a second carrier, and a third carrier, and receive a first measurement result and a second measurement result, the first measurement result being obtained by measuring the first carrier and the second carrier based on the measurement configuration information by the UE, the second measurement result being obtained by measuring the third carrier based on a measurement period by the UE, the measurement period being determined based on the first measurement result by the UE.

In accordance with an aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include receiving measurement configuration information, the measurement configuration information comprising information related to measurements of a first carrier, a second carrier, and a third carrier, measuring the first carrier and the second carrier based on the measurement configuration information to obtain a first measurement result, and determining a measurement period for the third carrier based on the first measurement result, and measuring the third carrier based on the measurement period.

In accordance with an aspect of the disclosure, a computer program product including a computer program, that when executed by a processor, implements the method performed by the user equipment (UE) or network node in the communication system is provided.

In the communication method, the user equipment, and the network node provided in the embodiments of the disclosure, the third carrier is adaptively measured according to the first measurement result of the first carrier and the second carrier, thereby improving the measurement accuracy.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of an overall structure of a wireless network according to an embodiment of the disclosure;

FIG. 2A is a schematic diagram of a transmission path according to an embodiment of the disclosure;

FIG. 2B is a schematic diagram of a reception path according to an embodiment of the disclosure;

FIG. 3A is a schematic structure diagram of a UE according to an embodiment of the disclosure;

FIG. 3B is a schematic structure diagram of a base station according to an embodiment of the disclosure;

FIG. 4A is a schematic diagram of using, by the UE, a separate RF chain to receive each fragmented carrier according to an embodiment of the disclosure;

FIG. 4B is a schematic diagram of the deployment of non-contiguous serving carriers according to an embodiment of the disclosure;

FIG. 4C is a schematic diagram of a key issue in using the first receiving mode according to an embodiment of the disclosure;

FIG. 5 is a flowchart of a method performed by a UE in a communication system according to an embodiment of the disclosure;

FIG. 6A is a schematic diagram of a fully shared reception (Rx) chain structure according to an embodiment of the disclosure;

FIG. 6B is a schematic diagram of another fully shared Rx chain structure according to an embodiment of the disclosure;

FIG. 7A is schematic diagram of a serving cell SSB-less measurement according to an embodiment of the disclosure;

FIG. 7B is schematic diagram of an SSB based serving cell measurement according to an embodiment of the disclosure;

FIG. 7C is a schematic diagram of an event-triggered reporting mechanism according to an embodiment of the disclosure;

FIG. 7D is a schematic diagram of the UE being not-at-cell edge according to an embodiment of the disclosure;

FIG. 8 is a schematic diagram of signal masking according to an embodiment of the disclosure;

FIG. 9 is schematic diagram of a window-based in-gap neighbor cell measurement method according to an embodiment of the disclosure;

FIG. 10 is a schematic diagram of a triggering condition of entering the second receiving mode according to an embodiment of the disclosure;

FIG. 11 is a schematic diagram of UAI information transmission according to an embodiment of the disclosure;

FIG. 12 is a schematic diagram of a dynamic measurement scenario according to an embodiment of the disclosure;

FIG. 13 is a schematic diagram of the details of a measurement mode according to an embodiment of the disclosure;

FIG. 14 is a schematic diagram of a network configuration supporting the use of the first receiving mode according to an embodiment of the disclosure;

FIG. 15A is a schematic diagram of in-gap interference from different operators according to an embodiment of the disclosure;

FIG. 15B is a schematic diagram of a frequency span of two non-contiguous CCs according to an embodiment of the disclosure;

FIG. 16 is a schematic diagram of a complete receiving mode switching process according to an embodiment of the disclosure;

FIG. 17 is a schematic diagram of a complete Rx chain switching process according to an embodiment of the disclosure; and

FIG. 18 is a schematic diagram of a structure of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

The various embodiments of the disclosure can be applied to various communication systems, such as: global system for mobile communications (GSM) system, code division multiple access (CDMA) system, broadband code division multiple access (WCDMA) system, general packet radio service (GPRS), long term evolution (LTE) system Frequency division duplex (FDD) systems, time division duplex (TDD) systems, universal mobile telecommunications systems (UMTS), global interoperability for microwave access (WiMAX) communication systems, fifth generation (5G) systems or new wireless (NR) systems, or the like. In addition, the various embodiments of the disclosure can be applied to future oriented communication technologies.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

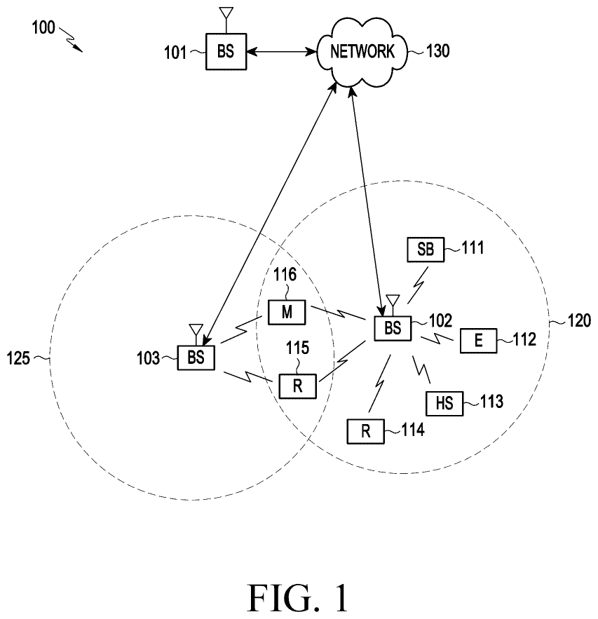

FIG. 1 illustrates an example wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 may include a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this patent document to refer to network infrastructure components that provide wireless access for remote terminals. Depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a Wi-Fi Hotspot (HS); a UE 114, which may be located in a first residence (R); a UE 115, which may be located in a second residence (R); a UE 116, which may be a mobile device (M), such as a cellular phone, a wireless laptop computer, a wireless personal digital assistant (PDA), or the like. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 may communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a two dimensional (2D) antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 may include any number of gNBs and any number of UEs in any suitable arrangement, for example. Furthermore, gNB 101 may directly communicate with any number of UEs and provide wireless broadband access to the network 130 for those UEs. Similarly, each gNB 102-103 may directly communicate with the network 130 and provide direct wireless broadband access to the network 130 for the UEs. In addition, gNB 101, 102 and/or 103 may provide access to other or additional external networks, such as external telephone networks or other types of data networks.

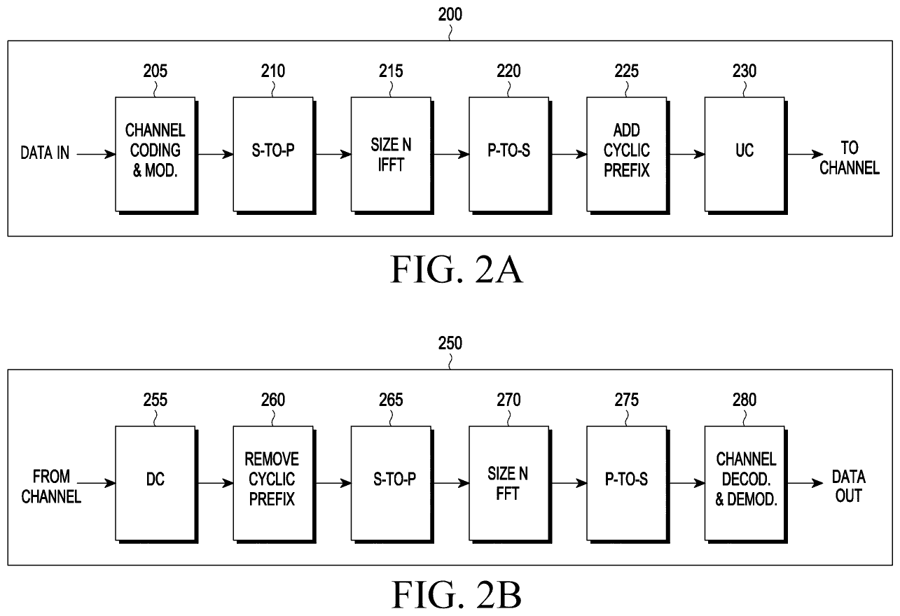

FIGS. 2A and 2B illustrate example wireless transmission and reception paths according to various embodiments of the disclosure. In the following description, the transmission path 200 may be described as being implemented in a gNB, such as gNB 102, and the reception path 250 may be described as being implemented in a UE, such as UE 116. However, it should be understood that the reception path 250 may be implemented in a gNB and the transmission path 200 may be implemented in a UE. In some embodiments, the reception path 250 is configured to support codebook designs and structures for systems with 2D antenna arrays as described in embodiments of the disclosure.

The transmission path 200 may include a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 may include a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives, for example, a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts, for example, a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B may be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the disclosure. Other types of transforms may be used, such as Discrete Fourier transform (DFT) and Inverse Discrete Fourier Transform (IDFT) functions. It should be understood that for DFT and IDFT functions, the value of variable N may be any integer (such as 1, 2, 3, 4, or the like.), while for FFT and IFFT functions, the value of variable N may be any integer which is a power of 2 (such as 1, 2, 4, 8, 16, or the like.).

Although FIGS. 2A and 2B illustrate examples of wireless transmission and reception paths, various changes may be made to FIGS. 2A and 2B. For example, various components in FIGS. 2A and 2B may be combined, further subdivided or omitted, and additional components may be added according to specific requirements. Furthermore, FIGS. 2A and 2B are intended to illustrate examples of types of transmission and reception paths that may be used in a wireless network. Any other suitable architecture may be used to support wireless communication in a wireless network.

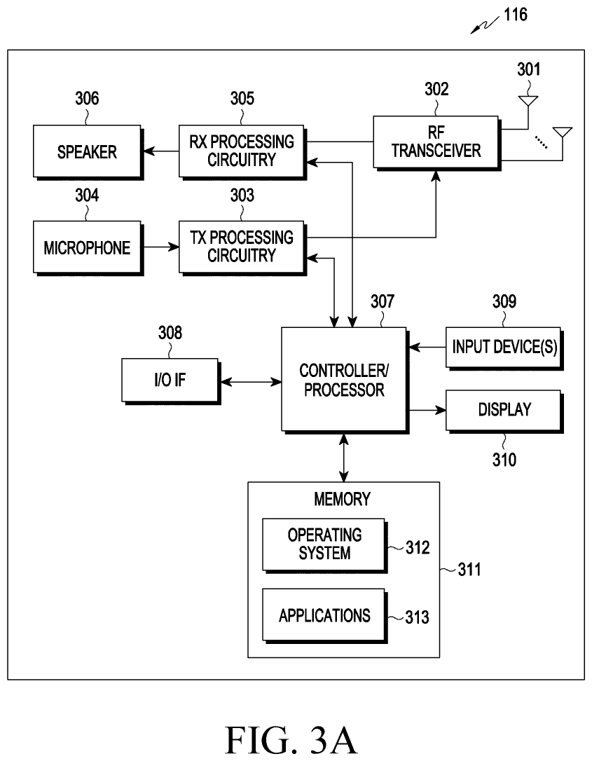

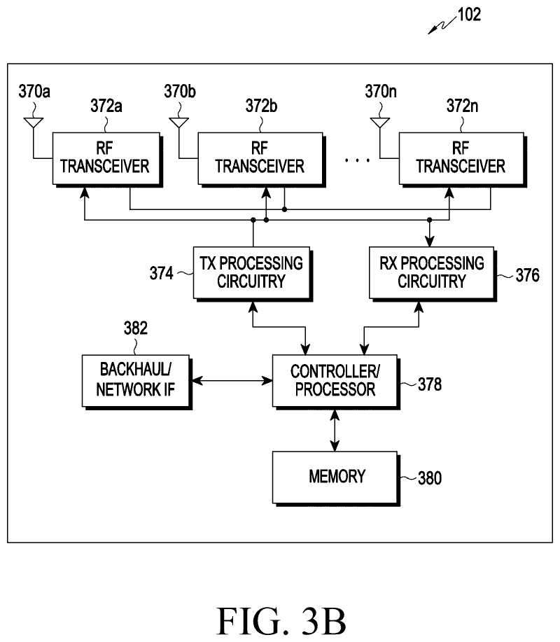

FIG. 3A illustrates an example UE 116 according to an embodiment of the disclosure. The embodiment of UE 116 shown in FIG. 3A is for illustration only, and UEs 111-115 of FIG. 1 may have the same or similar configuration. However, a UE has various configurations, and FIG. 3A does not limit the scope of the disclosure to any specific implementation of the UE.

Referring to FIG. 3A, UE 116 may include an antenna 301, a radio frequency (RF) transceiver 302, a transmission (TX) processing circuitry 303, a microphone 304, and a reception (RX) processing circuitry 305. UE 116 may also include a speaker 306, a controller/processor 307, an input/output (I/O) interface 308, an input device(s) 309, a display 310, and memory 311. The memory 311 may include an operating system (OS) 312 and one or more applications 313.

The RF transceiver 302 receives an incoming RF signal transmitted by a gNB of the wireless network 100 from the antenna 301. The RF transceiver 302 down-converts the incoming RF signal to generate an intermediate frequency (IF) or baseband signal. The IF or baseband signal is transmitted to the RX processing circuitry 305, where the RX processing circuitry 305 generates a processed baseband signal by filtering, decoding and/or digitizing the baseband or IF signal. The RX processing circuitry 305 transmits the processed baseband signal to speaker 306 (such as for voice data) or to controller/processor 307 for further processing (such as for web browsing data).

The TX processing circuitry 303 receives analog or digital voice data from microphone 304 or other outgoing baseband data (such as network data, email or interactive video game data) from controller/processor 307. The TX processing circuitry 303 encodes, multiplexes, and/or digitizes the outgoing baseband data to generate a processed baseband or IF signal. The RF transceiver 302 receives, for example, the outgoing processed baseband or IF signal from the TX processing circuitry 303 and up-converts the baseband or IF signal into an RF signal transmitted via the antenna 301.

The controller/processor 307 may include one or more processors or other processing devices and execute an OS 312 stored in the memory 311 in order to control the overall operation of UE 116. In an example, the controller/processor 307 may control the reception of forward channel signals and the transmission of backward channel signals through the RF transceiver 302, the RX processing circuitry 305 and the TX processing circuitry 303 according to well-known principles. In some embodiments, the controller/processor 307 may include at least one microprocessor or microcontroller.

The controller/processor 307 is also capable of executing other processes and programs residing in the memory 311, such as operations for channel quality measurement and reporting for systems with 2D antenna arrays as described in embodiments of the disclosure. The controller/processor 307 may move data into or out of the memory 311 as required by an execution process. In some embodiments, the controller/processor 307 is configured to execute the application 313 based on the OS 312 or in response to signals received from the gNB or the operator. The controller/processor 307 is also coupled to an I/O interface 308, where the I/O interface 308 provides UE 116 with the ability to connect to other devices such as laptop computers and handheld computers. I/O interface 308 is a communication path between these accessories and the controller/processor 307.

The controller/processor 307 is also coupled to the input device(s) 309 and the display 310. An operator of UE 116 may input data into UE 116 using the input device(s) 309. The display 310 may be a liquid crystal display or other display capable of presenting text and/or at least limited graphics (such as from a website). The memory 311 is coupled to the controller/processor 307. A part of the memory 311 may include a random access memory (RAM), while another part of the memory 311 may include a flash memory or other read-only memory (ROM).

Although FIG. 3A illustrates an example of UE 116, various changes may be made to FIG. 3A. For example, various components in FIG. 3A may be combined, further subdivided or omitted, and additional components may be added according to specific requirements. As a specific example, the controller/processor 307 may be divided into a plurality of processors, such as one or more central processing units (CPUs) and one or more graphics processing units (GPUs). Furthermore, although FIG. 3a illustrates that the UE 116 is configured as a mobile phone or a smart phone, UEs may be configured to operate as other types of mobile or fixed devices.

FIG. 3B illustrates an example gNB 102 according to an embodiment of the disclosure. The embodiment of gNB 102 shown in FIG. 3B is for illustration only, and other gNBs of FIG. 1 may have the same or similar configuration. However, a gNB has various configurations, and FIG. 3B does not limit the scope of the disclosure to any specific implementation of a gNB. It should be noted that gNB 101 and gNB 103 may include the same or similar structures as gNB 102.

Referring to FIG. 3B, gNB 102 may include a plurality of antennas 370a, 370b . . . 370n, a plurality of RF transceivers 372a, 372b . . . 372n, a transmission (TX) processing circuitry 374, and a reception (RX) processing circuitry 376. In certain embodiments, one or more of the plurality of antennas 370a, 370b . . . 370n include a 2D antenna array. gNB 102 may also include a controller/processor 378, memory 380, and a backhaul or network interface 382.

RF transceivers 372a, 372b . . . 372n receive an incoming RF signal from antennas 370a, 370b . . . 370n, such as a signal transmitted by UEs or other gNBs. RF transceivers 372a, 372b . . . 372n down-convert the incoming RF signal to generate an IF or baseband signal. The IF or baseband signal is transmitted to the RX processing circuitry 376, where the RX processing circuitry 376 generates a processed baseband signal by filtering, decoding and/or digitizing the baseband or IF signal. RX processing circuitry 376 transmits the processed baseband signal to controller/processor 378 for further processing.

The TX processing circuitry 374 receives analog or digital data (such as voice data, network data, email or interactive video game data) from the controller/processor 378. TX processing circuitry 374 encodes, multiplexes and/or digitizes outgoing baseband data to generate a processed baseband or IF signal. RF transceivers 372a, 372b . . . 372n receive the outgoing processed baseband or IF signal from TX processing circuitry 374 and up-convert the baseband or IF signal into an RF signal transmitted via antennas 370a, 370b . . . 370n.

The controller/processor 378 may include one or more processors or other processing devices that control the overall operation of gNB 102. For example, the controller/processor 378 may control the reception of forward channel signals and the transmission of backward channel signals through the RF transceivers 372a, 372b . . . 372n, the RX processing circuitry 376 and the TX processing circuitry 374 according to well-known principles. The controller/processor 378 may also support additional functions, such as higher-level wireless communication functions. For example, the controller/processor 378 may perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 may include at least one microprocessor or microcontroller.

The controller/processor 378 is also capable of executing programs and other processes residing in the memory 380, such as a basic OS. The controller/processor 378 may also support channel quality measurement and reporting for systems with 2D antenna arrays as described in embodiments of the disclosure. In some embodiments, the controller/processor 378 supports communication between entities such as web RTCs. In an example, the controller/processor 378 may move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 may support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 may allow gNB 102 to communicate with other gNBs through wired or wireless backhaul connections. When gNB 102 is implemented as an access point, the backhaul or network interface 382 may allow gNB 102 to communicate with a larger network, such as the Internet, through a wired or wireless local area network or through a wired or wireless connection. The backhaul or network interface 382 may include any suitable structure that supports communication through a wired or wireless connection, such as an Ethernet or an RF transceiver.

The memory 380 is coupled to the controller/processor 378. A part of the memory 380 can include an RAM, while another part of the memory 380 may include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a, 372b . . . 372n, TX processing circuitry 374 and/or RX processing circuitry 376) support aggregated communication with FDD cells and TDD cells.

Although FIG. 3B illustrates an example of gNB 102, various changes may be made to FIG. 3B. For example, gNB 102 may include any number of each component shown in FIG. 3A. As a specific example, the access point may include many backhaul or network interfaces 382, and the controller/processor 378 may support routing functions to route data between different network addresses. As another example, although shown as including a single instance of the TX processing circuitry 374 and a single instance of the RX processing circuitry 376, gNB 102 may include multiple instances of each (such as one for each RF transceiver).

The various embodiments of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples may be made without departing from the scope of the disclosure.

Wireless data traffic increases rapidly as a large number of intelligent devices are introduced. The use of larger channel bandwidth (BW) is crucial to meet the demand for rapid data traffic increase because larger channel bandwidth will realize the transmission of more wireless data traffic per second. This is based on one visible advantage of larger spectral bandwidth. However, due to the limited supply of 5G/sixth generation (6G) spectra, more and more mobile network operators (MNOs) begin to deploy strategic actions to obtain larger spectral bandwidth in the auction or prevent competitors from obtaining larger spectral bandwidth. Thus, the issue on fragmented carriers (FCs) is caused. Most operators cannot have wide contiguous spectrum blocks in many bands to give full play to the advantages of high-speed data services/high throughput. As a result, these operators begin to use a spectrum aggregation (SA) or carrier aggregation (CA) technology, which aggregates a plurality of narrower contiguous spectrum blocks or narrower non-contiguous spectrum blocks to really form a wider spectrum to obtain larger transmission bandwidth, so as to achieve high data rate and high throughput gain.

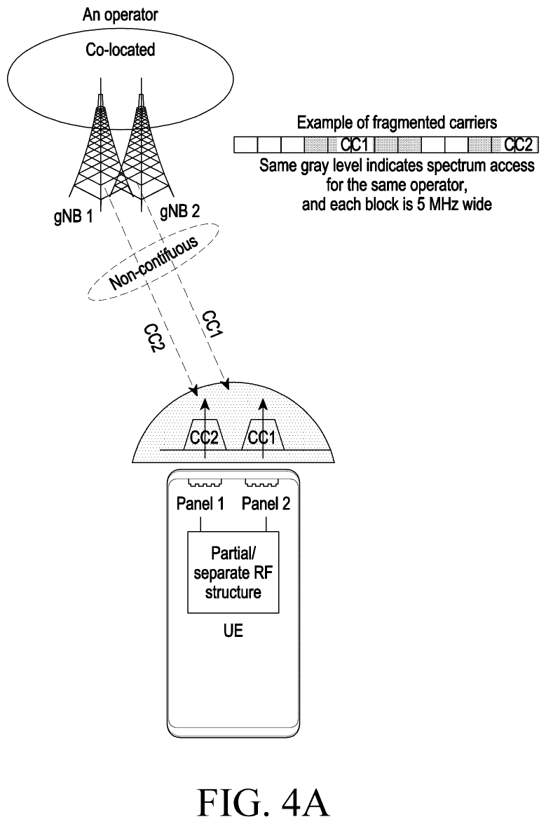

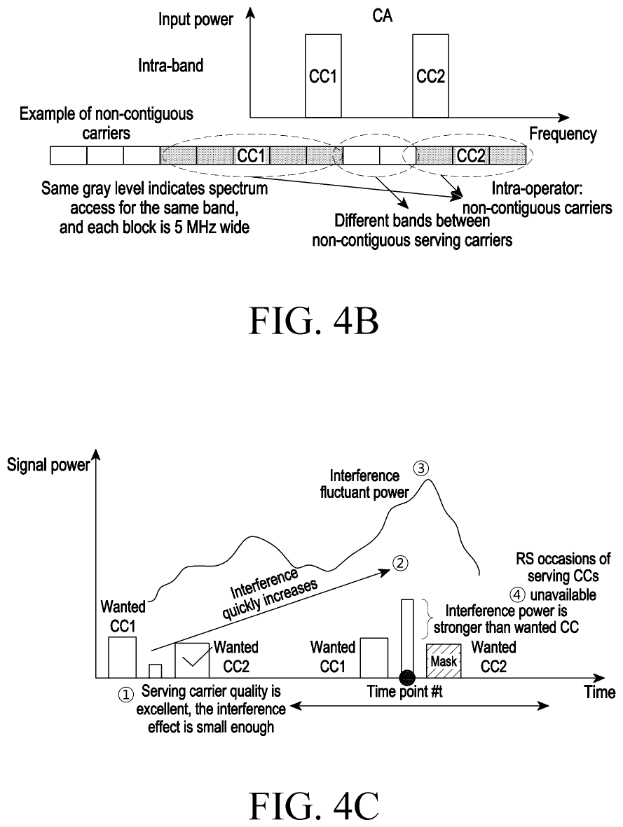

FIG. 4A is a schematic diagram of using, by the UE, a separate RF chain to receive each fragmented carrier according to an embodiment of the disclosure.

FIG. 4B is a schematic diagram of the deployment of non-contiguous serving carriers according to an embodiment of the disclosure.

FIG. 4C is a schematic diagram of a key issue in using the first receiving mode according to an embodiment of the disclosure.

In the related art, for the co-located downlink intra-band non-contiguous CA deployment in one band/operator/same operator, as shown in FIGS. 4A and 4B, the UE supports the use of a separate RF chain/Rx chain structure to receive each fragmented carrier (e.g., non-contiguous serving carrier).

However, the number of component carriers (CCs) that can be supported by the UE is limited. The difficulty in preventing the UE from supporting more CCs lies in the limitation of RF chains, as well as the limitation of baseband resources. The UE needs to reserve baseband processing resources for each CC, including time-frequency synchronization resources, radio resource management (RRM) measurement resources, physical downlink control channel (PDCCH) monitoring resources, and so on. If there are more CCs that can be supported, the UE implementation is more complex. Thus, especially for a high-order CA configuration, the maximum number of fragmented carriers supported by the UE will be limited if a separate RF chain is used to receive each fragmented carrier. One optional implementation is to decrease the number of Rx RF chains for fragmented carriers (e.g., using the RF first receiving mode) to increase the number of carriers that can be aggregated by the UE using released Rx chain resources.

However, when the RF first receiving mode is used to receive and measure fragmented carriers, the following issues will be caused by the change of signal power, as shown in FIG. 4C. It may be observed from FIG. 4C that the measurement frequency of non-contiguous serving carriers (corresponding to carrier 1 and carrier 2) and in-gap carriers (corresponding to carrier 3) is related to the serving cell measurement quality.

Signal power status (SPS) 1: the serving carrier quality is excellent, and the interference effect is small enough. The key issue (KI) 1 caused at this time is as follows: if the in-gap RRM measurement between two non-contiguous serving carriers is performed frequently at this time, high UE power loss and measurement gap (MG) overhead will be caused.

SPS2: the in-gap interference power of non-contiguous serving carriers quickly increases. The KI2 caused at this time is as follows: long-time in-gap RRM measurement is not enough to reflect the rapid change of interference power and the serving carrier quality is very poor.

SPS3: the in-gap interference power of non-contiguous serving carriers is fluctuant. The KI3 caused at this time is as follows: inaccurate in-gap RRM measurement results will lead to the ping-pong effect of serving cell addition/release.

SPS4: the in-gap interference power of non-contiguous serving carriers is large enough, and the reference signal occasions of serving cells become unavailable. The KI4 caused at this time is as follows: the performance of serving cell Layer 3 (L3)/Layer 1 (L1) measurement is poor.

Optionally, the L1 measurement may include: L1-reference signal received power (PRRP)/L1-signal to interference plug noise ratio (SINR)/beam failure detection (BFD), or the like.; and, the L3 measurement may include: inter-frequency measurement/intra-frequency measurement, and radio link monitor, or the like.

Based on the above description of the SPSs and KIs, due to the change of in-gap interference energy/power of non-contiguous serving carriers, the UE is not expected to always comply with the corresponding measurement requirements.

In view of the at least one technical problem or place to be improved in the related art, the disclosure provides a communication method, a user equipment, and a network node, which improve the accuracy of in-gap measurement of non-contiguous serving carriers by optimizing the measurement requirements of receiving non-contiguous serving carriers.

The technical solutions in the embodiments of the disclosure and the technical effects achieved by the technical solutions of the disclosure will be explained below by describing several implementations. It should be pointed out that the following implementations may be referred to, learned from or combined with each other, and the same terms, similar features and similar implementation steps/operations in different implementations will not be repeated.

An embodiment of the disclosure provides a method performed by a UE in a communication system.

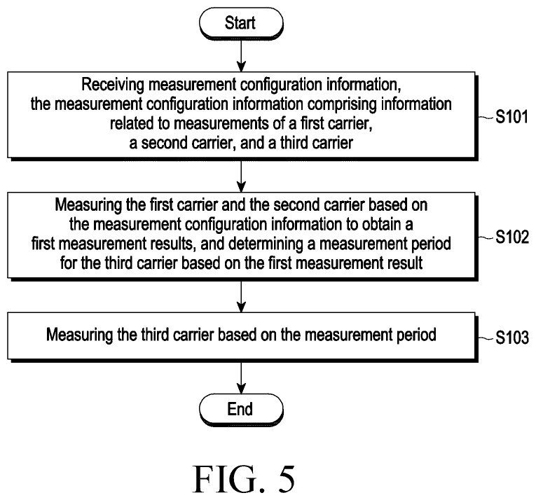

FIG. 5 is a flowchart of a method performed by a UE in a communication system according to an embodiment of the disclosure.

Referring to FIG. 5, the method may include the following operations.

At Operation S101: Receiving measurement configuration information, the measurement configuration information comprising information related to measurements of a first carrier, a second carrier, and a third carrier.

In an embodiment of the disclosure, the measurement configuration information is received, and corresponding measurement and reporting are performed. Optionally, the reporting mode is configured by a higher layer. For example, the measurement configuration information may include a measurement report configuration.

In an embodiment of the disclosure, the first carrier and the second carrier are non-contiguous carriers, which may also be referred to as non-contiguous carriers for carrier aggregation in a same band, or may be referred to as target carriers, wanted carriers, expected carriers, desired carriers, serving carriers in a same band, non-contiguous carriers in a same band, carriers in a same cell, serving carriers from a same operator, fragmented carriers, segmented carriers, segment carriers, or the like., which will not be limited in the embodiments of the disclosure. Hereinafter, the first carrier and the second carrier may be described as non-contiguous carriers or non-contiguous serving carriers.

In an embodiment of the disclosure, the third carrier may refer to a carrier between non-contiguous serving carriers (in-gap), and may include (or be referred to as) inter-operator (also referred to as different operators) in-gap interference, in-gap interference, in-gap neighbor cell carrier, neighbor cell carrier, in-gap signal, inter-band signal, inter-frequency interference, inter-carrier interference in a same cell, unwanted signal, inter-operator unwanted signal, unwanted signals from different operators, or the like., which will not be limited in the embodiments of the disclosure. Hereinafter, the third carrier may be described as an in-gap signal, and the measurement of the third carrier may be described as in-gap measurement.

Optionally, there may be multiple third carriers between the first carrier and the second carrier, that is, there may be at least one in-gap carrier between non-contiguous serving carriers. If there are multiple in-gap carriers, multiple in-gap carriers may be defined as one measurement period, but the scaling factor and/or sharing factor CSSF related to the multiple in-gap carriers needs to be defined. Each third carrier may be measured by the method provided in the embodiments of the disclosure.

Optionally, the non-contiguous serving carriers from a same band may correspond to at least two non-contiguous serving carriers from a same operator.

Optionally, when the UE uses a first receiving mode to simultaneously receive non-contiguous serving carriers from a same operator, the in-gap signal may be assumed as at least one adjacent channel downlink carrier interference from different operators.

The in-gap signal may be assumed as neighbor cell carrier signals from different bands.

Optionally, at least two serving carriers in a same cell may be contiguous serving carriers, or may also be non-contiguous serving carriers. At this time, the in-gap signal may be other carriers between non-contiguous serving carriers in the same cell.

This operation may also be described as follows: the measurement configuration information may include information related to measurement of non-contiguous serving carriers for carrier aggregation from a same band, and information related to in-gap measurement of non-contiguous serving carriers; and, the in-gap measurement may include measurement of interference from different bands between non-contiguous serving carriers, and/or measurement of neighbor cells from different bands between non-contiguous serving carriers.

At Operation S102: Measuring the first carrier and the second carrier based on the measurement configuration information to obtain a first measurement result, and determining a measurement period for the third carrier based on the first measurement result.

That is, the non-contiguous carriers are measured based on the measurement configuration information to obtain a first measurement result, and a measurement period related to in-gap measurement is determined based on the first measurement result.

Optionally, according to the first measurement result of the serving carriers and the corresponding conditions and based on the non-contiguous serving carrier related configuration, the UE adaptively determines different measurement periods to measure the in-gap signal between non-contiguous serving carriers.

At Operation S103: Measuring the third carrier based on the measurement period.

That is, in-gap measurement is performed based on the measurement configuration information and the measurement period related to in-gap measurement to obtain a second measurement result.

The solutions provided in the embodiments of the disclosure may at least solve the following pain point: for a CA configuration supporting fragmented carriers, how to adaptively perform in-gap measurement based on different measurement periods to ensure serving carrier downlink (DL) performance and improve data throughput, specifically, how to use the channel link quality or measurement results (first measurement result) of serving carriers to robustly trigger in-gap RRM measurement with different measurement periods.

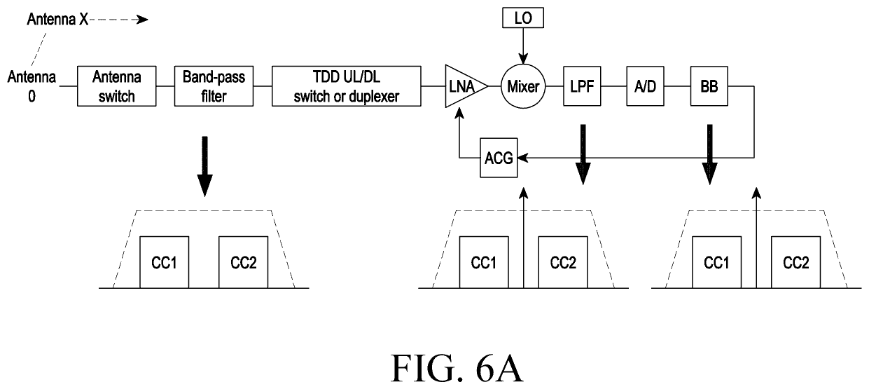

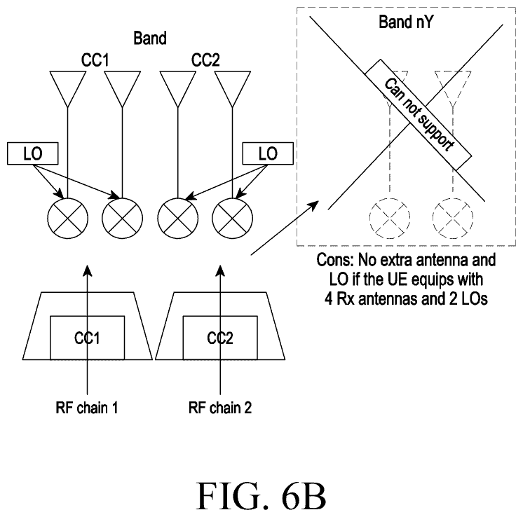

FIG. 6A is a schematic diagram of a fully shared reception (Rx) chain structure according to an embodiment of the disclosure.

FIG. 6B is a schematic diagram of another fully shared Rx chain structure according to an embodiment of the disclosure.

In the embodiments of the disclosure, a precondition for the above measurement mode may include the UE capabilities and necessary network (NW) configurations to support fragmented carrier measurement by using the RF first receiving mode. Optionally, the UE may support a first capability that includes a capability of using the first receiving mode to receive the first carrier and the second carrier. It may also be described as that the first capability includes a capability of using the first receiving mode to receive at least two non-contiguous serving carriers from a same band (a same operator).

For non-contiguous FR1 frequency division duplex (FDD) bands, the UE with the first capability uses the RF first receiving mode to receive at least two non-contiguous carriers from a same band (e.g., a same operator). The structure of the RF first receiving mode is shown in FIG. 6A or 6B. An RF signal enters from an antenna, passes through a band-pass filter and a time division duplex (TDD) uplink (UL)/downlink (DL) switch or duplexer to be passed to an input terminal of a low noise amplifier (LNA), and a base band signal is output through an RF mixer (to which a local oscillator (LO) signal is applied), a low pass filter (LPF), an analog to digital (A/D) converter and a base band (BB) filter, and a gain control is provided through an automatic gain control (AGC). The fully shared Rx chain architecture may use a wide analog filter to cover the entire frequency span from the lower edge of CC1 to the upper edge of CC2, and thus may simultaneously receive more non-contiguous CCs, compared with the separate Rx chain structure that uses two narrow BB filters to cover CC1 and CC2.

Considering the change of in-gap interference energy/power of non-contiguous serving carriers described in the above SPSs and KIs, in the embodiments of the disclosure, the UE is not expected to always use the RF first receiving mode to simultaneously receive non-contiguous serving carriers. This is because the UE may use the RF first receiving mode to receive and process fragmented CCs when the interference power level is at an appropriate value.

The UE may determine, based at least one of the first measurement result, a second measurement result of measuring the third carrier and a switching condition, whether to switch from the first receiving mode to a second receiving mode to receive the first carrier and the second carrier, or whether to use the first receiving mode to receive a primary component carrier in the first carrier and the second carrier. It may also be descried as that the UE may determine, based on at least one of the first measurement result, the second measurement result and the switching condition, whether to switch from the first receiving mode to the second receiving mode to receive the first carrier and the second carrier (non-contiguous carriers from a same band), or whether to use the first receiving mode to receive a primary component carrier in the non-contiguous serving carriers.

The first receiving mode may refer to receiving by one/same/shared/fully shared RF chain, and the second receiving mode may refer to receiving by a separate/disconnected RF chain, but not limited thereto.

In the embodiments of the disclosure, the Rx chain may also be referred to as an RF chain or RF Rx chain, which will not be limited in the embodiments of the disclosure.

In the embodiments of the disclosure, if it is assumed that the UE that supports the first capability uses the RF first receiving mode (e.g., fully shared Rx chain structure) to receive at least two non-contiguous serving carriers from a same band (e.g., a same operator) by default, the switching condition may be interpreted as determining whether the in-gap interference power level is too high.

In the embodiments of the disclosure, for example a precondition of using the RF first receiving mode may include: using the in-gap interference power level as a decisive condition of triggering switching. Optionally, a way of defining the switching condition is comparing the measurement result with the corresponding criterion. Based on the defined switching condition, hardware resources are semi-statically switched to enable/release the Rx chain. According to whether the switching condition is met, the UE may fall back to the second receiving mode (e.g., partially shared Rx chain or separate Rx chain) and use the legacy measurement requirement.

In practical applications, the specific switching condition and the corresponding specific threshold may be set according to the actual situation and will not be limited in the embodiments of the disclosure.

In an example, if the in-gap interference power level is too high and a fully shared Rx chain is used currently, the fully shared Rx chain may be switched to a separate Rx chain to receive at least two non-contiguous serving carriers from a same band (e.g., a same operator).

If the in-gap interference power level is lower and a fully shared Rx chain structure is used currently, the fully shared Rx chain structure may be continuously used to receive at least two non-contiguous serving carriers from a same band (e.g., a same operator).

In the method provided in an embodiment, for a UE that supports the first capability, by using a new measurement requirement for the first receiving mode (e.g., fully shared Rx chain structure) on the UE side and in combination with a new receiving mode switching condition (e.g., Rx chain structure switching condition), the receiving mode (e.g., Rx chain structure) may be flexibly switched through in-gap measurement, so that the UE is allowed to support the simultaneous reception of more non-contiguous component carriers, and the purpose of the balance of performance of target carriers is ensured.

In an embodiment of the disclosure, when the in-gap includes interference from different bands, the in-gap measurement includes in-gap interference received signal strength indication (RSSI) measurement; and/or, when the in-gap includes neighbor cells from different bands, the in-gap measurement includes in-gap neighbor cell RSRP measurement and/or reference signal receiving quality (RSRQ) measurement.

In other words, the neighbor cell quantity measurement refers to RSRP and/or RSRQ measurement under the FC scenario or related to FC. The in-gap measurement refers to RSSI measurement under the FC scenario or related to FC.

Further, the Rx chain structure may be flexibly switched through the measurement results of in-gap interference RSSI or the measurement results of in-gap neighbor cell or neighbor carrier RSRP/RSRQ and the corresponding triggering conditions.

The solutions provided in the embodiments may at least solve the following pain point: how to switch between the RF first receiving mode and the RF second receiving mode based on the measurement results. By optimizing the scheme of using the receiving modes (Rx chains) for receiving at least two non-contiguous serving carriers from a same cell, the flexible use of the receiving modes (e.g., Rx chain structures) is realized.

In combination with the above at least one embodiment, in a connected mode, for a UE that supports fragmented carriers and uses the RF first receiving mode to receive the combination of CA bands, the UE uses the first receiving mode for measurement on two serving carriers. The UE may adaptively use different measurement periods to measure in-gap signals between two serving carriers based on the fragmented carrier related configuration according to the serving carrier measurement results and the corresponding conditions. The detailed description and the effects may specifically refer to the above description and will not be repeated here.

In various embodiments, the following optional implementations are provided for determining the measurement period for the third carrier.

In a first optional implementation, when the first measurement result is larger than a first threshold, a first measurement period for (in-gap measurement of) the third carrier is determined based on a first scaling factor. The first scaling factor is a measurement relaxation factor used for measurement relaxation.

Optionally, in this implementation, the first measurement result may refer to the serving cell measurement quantity RSRP/RSRQ, and the condition 1 (Th_enter_ingaprelax) corresponding to the situation where the first measurement result is larger than a first threshold may be, for example, represented as Srxlev_FC>Z1 and/or Squal_FC>Z2, where Srxlev_FC represents the serving cell RSRP measurement related to non-contiguous serving carriers, and Squal_FC represents the serving cell RSRQ measurement related to fragmented carriers. Z1 and Z2 represent the corresponding first thresholds, and the condition 1 is that the serving cell channel quality is excellent and the interference effect is small enough. If the condition 1 based on the serving cell measurement quantity RSRP/RSRQ is met, the UE performs relaxed in-gap measurement. The first measurement period for relaxed in-gap measurement is related to the first scaling factor. The first scaling factor may also be referred to as a relaxation factor K used for the relaxed measurement period.

In a second optional implementation, when the first measurement result is smaller than the first threshold and larger than a second threshold, the UE may perform normal in-gap measurement, where the normal in-gap measurement period is related to the configured legacy measurement parameter.

In this implementation, the first measurement result may refer to the serving cell measurement quantity RSRP/RSRQ, and the condition 2 (Th_enter_ingapnormal) corresponding to the situation where the first measurement result is smaller than the first threshold and larger than the second threshold may be, for example, represented as RSRP<Z1, RSRQ<Z2 and RSRP>Threshold A, where Z1 and Z2 represent the corresponding first thresholds, Threshold A represents the second threshold, and the condition 2 is that the serving cell channel quality is good and the interference effect is small and increases. If the condition 2 based on the serving cell measurement quantity RSRP/RSRQ is met, the UE performs normal in-gap measurement.

In a third optional implementation, when the first measurement result is smaller than the second threshold, a second measurement period for the third carrier is determined based on at least one of an interference RSSI measurement timing configuration (RMTC) of the third carrier (e.g., in-gap), a discontinuous reception cycle, a measurement in-gap carrier specific scaling factor (CSSF) and a measurement gap period (MGP, or referred to as measurement gap repetition period (MGRP)) of the third carrier (that is, in-gap), wherein the second measurement period is related to RSSI measurements.

Or, when the first measurement result is smaller than the second threshold, a third measurement period for the third carrier is determined based on at least one of a period of reference signals transmitted on downlink carriers in different bands and the number of samples required for reference signal received power (RSRP) measurement of the third carrier (e.g., in-gap) in different bands.

Or, when the first measurement result is smaller than the second threshold, a fourth measurement period for the third carrier is determined based on at least one of the total number of samples to be measured, a period of reference signals transmitted on the third carrier (e.g., in-gap neighbor cell carrier), a second scaling factor related to Layer 1 and/or Layer 3 measurements and a measurement period lower bound related to UE capabilities, where the second scaling factor is a measurement relaxation factor used for measurement relaxation.

In this implementation, the second measurement period, the third measurement period and the fourth measurement period may realize short in-gap measurement periods. The first measurement result related to the second measurement period may refer to the serving cell in-gap interference RSSI. The first measurement result related to the third measurement period may refer to the in-gap neighbor cell measurement quantity RSRP. The first measurement result related to the fourth measurement period may refer to the serving cell in-gap interference RSSI.

Optionally, for the in-gap RSSI measurement, the short in-gap measurement period (second measurement period) is related to a new measurement granularity, where the new measurement granularity is related to at least one of the RMTC period, the DRX cycle and the MG period.

For inter-frequency RSRP measurement, the shot in-gap measurement period (third measurement period) is related to the in-gap CSSF and the period of reference signals transmitted on in-gap carriers in different bands.

With regard to the fourth measurement period, measuring the third carrier based on the fourth measurement period may include determining a measurement window based on the fourth measurement period and a measurement result reporting configuration period, and performing the RSRP measurement on the third carrier (e.g., in-gap neighbor cell) in the measurement window.

Optionally, the RSRP measurement performed on the third carrier in the measurement window may include Layer 3 and/or Layer 1 RSRP measurement.

The measurement window may also be referred to as fast measurement window, or window for short, or may also be referred to as fast measurement duration, measurement duration, duration, or the like.

In this implementation, the condition 3 (Th_enter_ingapfast) corresponding to the situation where the first measurement result is smaller than the second threshold may be, for example, represented as RSRP<Threshold A, where Threshold A represents the second threshold. Optionally, the condition 3 may further include: the in-gap measurement results are larger than a fifth threshold. For example, the condition 3 may be represented as in-gap: RSRP>Threshold B and/or RSSI>Threshold C, where Threshold B and Threshold C represent the fifth threshold, and the condition 3 is that the serving cell channel quality is very poor and the interference effect cannot be ignored. If the condition 3 based on the serving cell measurement quantity RSRP and/or in-gap interference RSSI is met, the UE performs the fast in-gap measurement.

When the first measurement result is smaller than the second threshold, the UE may also determine, based on the number of reference signal occasions unavailable for measurement in the first measurement period, a fifth measurement period for measurement of the first carrier and the second carrier (non-contiguous carriers), wherein the number of reference signal occasions unavailable for measurement in the measurement period may include at least one of the number of synchronization signal block (SSB) measurement timing configuration (SMTC) occasions unavailable for synchronization signal measurement in the measurement period and the number of SSB occasions unavailable for Layer 1 measurement in the measurement period.

Optionally, the number of reference signal occasions unavailable for measurement is related to at least one of: a DRX cycle (configuration) and a reference signal period (configuration).

In this implementation, the fifth measurement period may realize extended serving cell measurement. The extended serving cell measurement period is related to the number of reference signal occasions unavailable to the UE during measurement due to in-gap interference.

Optionally, if the condition 3 based on the serving cell measurement quantity RSRP and/or in-gap interference RSSI is met, the UE performs the fast in-gap measurement and extended serving cell measurement.

Optionally, if the condition 3 based on the serving cell measurement quantity RSRP and/or in-gap interference RSSI is met, after an evaluation period, the UE reports a measurement result or fast measurement event with or without the X-bit L1/L2 fast measurement activation instruction of the network, and the UE performs the fast in-gap measurement and extended serving cell measurement.

Optionally, for the above at least one embodiment, the in-gap interference measurement results may be normalized results adapted to different bandwidths of the in-gap signals. This is because the accuracy requirement of RSSI measurement should allow for different UE implementations, as well as the applicability to intra-frequency and inter-frequency RSSI measurements. However, since different operators have different BWs, the interference levels from different operators are different. Under the condition of meeting the accuracy performance, the number of physical resource blocks (PRBs) selected for RSSI measurement is based on the UE implementation, and the RSSI reported by different UEs may not be uniform and comparable. To make the defined triggering condition adapt to all scenarios, e.g., to uniformly compare the RSSI with the given threshold to realize accurate switching, an optional way of reporting the interference measurement results is provided.

The UE may normalize a measurement result of measuring the third carrier based on the second measurement period, according to at least one of: a default measurement bandwidth used for measurement, and the number of frequency-domain units; and the UE reports the normalized measurement result.

The frequency-domain unit (also referred to as frequency unit) may be a sub-carrier, a sub-carrier group (consisting of multiple sub-carriers), a resource block (RB) (also referred to as physical resource block (PRB)), a resource block group (consisting of multiple RBs), a bandwidth part (BWP), a bandwidth part group (consisting of multiple BWPs), a band/carrier or a band group/carrier group, or may be an absolute frequency-domain unit, e.g., 1 Hz, 1 KHz, or the like. The frequency-domain unit may also be a combination of multiple granularities, e.g., M1 PRBs plus M2 sub-carriers, or the like.

Optionally, the UE may report, to the network, accurate or normalized RRSI measurement per sub-band or per PRB, or RSSI measurement per MHz.

As an example, normalization may be performed by using the number N_{PRB} of PRBs (default measurement BW) used for measurement by the UE. For example, the normalized first interference measurement result is RSSI_{FCuse}=RSSI/N_{PRB}.

In the embodiments of the disclosure, the RSSI reporting mode may be reporting the normalized measurement value dBm per MHz, or normalized measurement value per sub-band, or normalized measurement value per PRB.

In the embodiments of the disclosure, the UE may normalize the in-gap interference RSSI measurement results according to the implementation, so that the RSSIs reported by different UEs are comparable, and the interference level of a given carrier (e.g., interference carrier) may be really determined by the network using the RSSI measurement value.

In the embodiments, in the FC scenario, the inter-operator in-gap RSSI measurement may include at least one of:
(1) inter-frequency and intra-frequency RSSI measurements with a measurement gap; and
(2) intra-frequency RSSI measurement without a measurement gap.

In the embodiments of the disclosure, with regard to the above condition 1 (Th_enter_ingaprelax, the first threshold Z1/Z2), when measuring the third carrier based on the first measurement period, the UE may also perform an SSB-less based measurement or an SSB based measurement for a secondary component carrier in the first carrier and the second carrier (non-contiguous carriers).

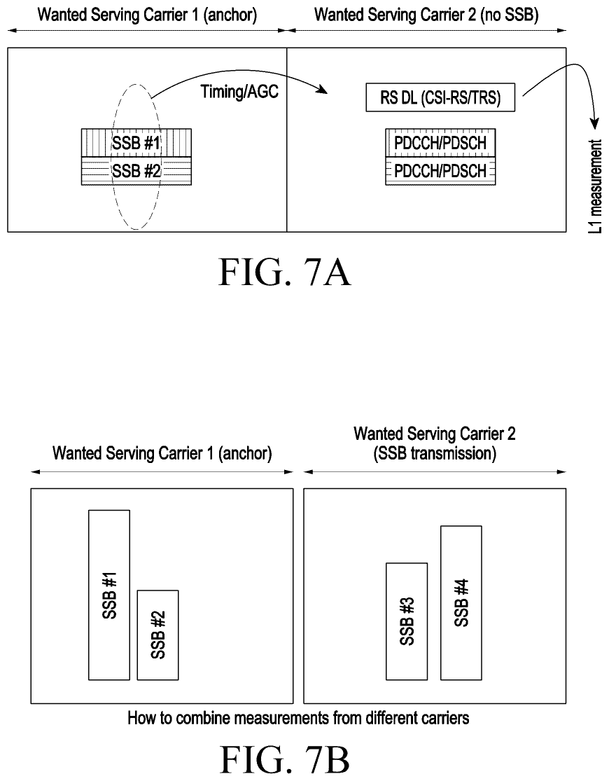

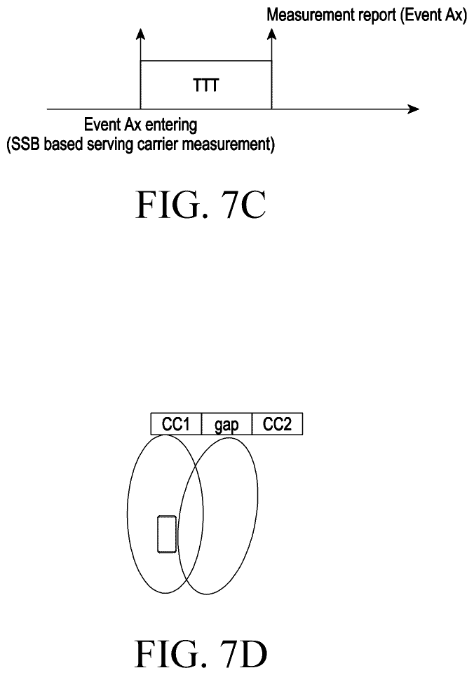

Optionally, the serving cell period measurement may consider SSB-less, referring to FIG. 7A, or SSB-based, referring to FIG. 7B.

FIG. 7A is schematic diagram of a serving cell SSB-less measurement according to an embodiment of the disclosure.

FIG. 7B is schematic diagram of an SSB based serving cell measurement according to an embodiment of the disclosure.

FIG. 7C is a schematic diagram of an event-triggered reporting mechanism according to an embodiment of the disclosure.

FIG. 7D is a schematic diagram of the UE being not-at-cell edge according to an embodiment of the disclosure.

Situation 1: SSB-less measurement on the secondary component carrier (e.g., CC2 in FIG. 7A) in the non-contiguous serving carriers.

The reason and principle are as follows: the power imbalance <=6 dB, the deployment of the maximum receiving timing difference (MRTD) less than 3 us and frequency span and the single-RF chain processing are taken into consideration. Based on the above reason, the channel characteristics may be greatly similar. On this basis, coarse timing or AGC setting may be performed on the wanted serving carrier 1 (anchor serving carrier), and the symbols not used for SSB transmission on the wanted serving carrier 2 (secondary component carrier) may be allocated for data transmission, for example, physical downlink shared channel (PDSCH), physical downlink control channel (PDCCH), or the like. An additional advantage of SSB-less is that the symbols on carrier 2 are released for data transmission and the resource overhead is reduced.

In an example, by taking RRM measurement (e.g., L1-RSRP measurement) as an example, the measurement on serving carrier 2 may be skipped, and the transceiver configuration indicator (TCI) state information may be established at this time by using information obtained by measurement on serving carrier 1. The PDSCH/PDCCH or the like on serving carrier 2 and the SSB on serving carrier 1 are Quasi co-located (QCL-ed).

Optionally, a necessary measurement is still performed on serving carrier 2, and the used downlink measurement reference signal is a channel state information-reference signal (CSI-RS) or a tracking reference signal (TRS).

Situation 2: SSB based measurement on the secondary component carrier (e.g., CC2 in FIG. 7B) in the non-contiguous serving carriers.

The reason and principle are as follows: the reference signals (RSs) measured with/without gap on different cells in different frequency layers are synchronized, and the reference signals on the wanted serving carrier 1 (anchor serving carrier) and wanted serving carrier 2 (secondary component carrier) are aligned to adjust AGC.

In an example, the RRM measurement and result reporting method may be as follows: the worst value in all measurement results is reported. The UE performs serving cell measurement on each frequency layer in a time-division multiplexing (TDM) mode; the UE performs measurement and filtering based on each SSB in the measurement period; and, the worst value is reported after result evaluation. As shown in FIG. 7B, SSB #2 is reported.

The RRM measurement and result reporting mechanism is as follows: result reporting may be periodic or may also be event-triggered, where the event-triggered reporting is as shown in FIG. 7C. For event-triggered reporting, when the accuracy meets |SSB_worst|<Pre-configured threshold in the configured time to trigger (TTT), the UE automatically reports the worst valid L3 measurement result.

For in-gap relaxed measurement, low-frequency measurement is ensured, and the accuracy requirement needs to be met. At this time, the RSRP (dBm) of serving cells in a same band is excellent (e.g., >=threshold Z1 (e.g., >=−75 dBm)).

Optionally, the in-gap signal relaxed measurement condition may be as follows: based on the threshold configured for the UE and based on the following conditions, the UE evaluates whether the power or quality of serving cells is appropriate: Srxlev_FC>Z₁ and Squal_FC>Z₂. Optionally, different Z1 and Z2 are configured by the network according to different UE conditions. Optionally, the UE condition may mean that the UE is not-at-cell edge, as shown in FIG. 7D; or the UE is at low mobility.

In an example, the way of determining the relaxed measurement period T_{SSB_measurement_period_inter_FC} used for in-gap neighbour cell (inter-band) RSRP measurement of non-contiguous serving carriers may be as shown in Table 1:

TABLE 1

| Condition | T_{SSB}_{_{—}}ₘₑₐₛᵤᵣₑₘₑₙₜ_{_{—}}_{period}_{_{—}}ᵢₙₜₑᵣ_{_{—}}_{FC} |
|---|---|
| No DRX | Max(200 ms, Ceil(8 × K_{gap}) × |
| | Measurement interval) × CSSFᵢₙₜₑᵣ |
| DRX cycle ≤ 320 ms | Max(200 × K1, Ceil(8 × 1.5 |
| | * K_{gap} × K2) × |
| | Measurement interval) × CSSFᵢₙₜₑᵣ |
| DRX cycle > 320 ms | Ceil(8 |
| | * K_{gap}) × DRX cycle × CSSFᵢₙₜₑᵣ |

To obtain a long RRM measurement period, the in-gap measurement frequency needs to be reduced, and a relaxation factor K is introduced. Considering different DRX cycle configurations, SMTC configurations and channel conditions, optionally, K>4. Theoretically, when DRX≤320 ms, the measurement period lower bound and the measurement period need to be relaxed and may be defined as K1 and K2, respectively. Optionally, K1=K2>4.

In Table 1, DRX cycle represents the DRX cycle, CSSFᵢₙₜₑᵣ represents the carrier specific relaxation factor used for measurement in the measurement gap (MG), and Measurement interval represents the measurement gap, may be defined as different parameters depending on different measurement tasks and is related to at least one of the MG period (MGRP), the SMTC period and the DRX cycle. In an example, considering FR1 inter-frequency RSRP measurement with a measurement gap, when the DRX cycle <320 ms, Measurement interval=Max(MGRP, SMTC period, DRX cycle); and, when there is no DRX, Measurement interval=Max(MGRP, SMTC period), and Kgap is related to the MG mode and will be taken into consideration when the UE supports concurrentMeasGap-r17.

In an example, the way of determining the relaxed measurement period T_{RSSI_measurement_period_inter_FC} used for inter-frequency RSSI measurement with a measurement gap may be as shown in Table 2:

TABLE 2

| Condition | T_{RSSI}_{_{—}}ₘₑₐₛᵤᵣₑₘₑₙₜ_{_{—}}_{period}_{_{—}}ᵢₙₜₑᵣ_{_{—}}_{FC} |
|---|---|
| No DRX | max(reportInterval, max(rmtc- Periodicity, |
| | MGRP) × CSSFᵢₙₜₑᵣ) |
| DRX | max(reportInterval, max(rmtc- Periodicity, MGRP, |
| | DRX cycle) × K3 × CSSFᵢₙₜₑᵣ) |

Considering different DRX cycle configurations, RMTC period configurations, channel conditions and MG period configurations, optionally, the relaxation factor K3>2.

In Table 2, rmtc-Periodicity is a parameter related to the RSSI measurement periodicity, reportInterval is a report interval indicating how long reporting is repeatedly triggered, MGRP is the MG period, DRX cycle is the DRX cycle, and CSSFᵢₙₜₑᵣ is the carrier specific relaxation factor used for measurement in the measurement gap (MG).

In various embodiments of the disclosure, with regard to the above condition 2 (Th_enter_ingapnormal, the second threshold Threshold A), the RSRP (dBm) of serving cells in a same band is good (e.g., >=threshold A (e.g., >=−95 dBm)). At this time, the process may fall back to the normal measurement (e.g., from the relaxed measurement period) after the evaluation period. The evaluation period may be configured by the network. This is because it is infeasible to relax and ignore any in-gap interference tracking if limited serving cell performance effect is allowed as long as the serving cell RSRP falls back to a slightly smaller range.

In an example, considering RSSI measurement, the RSSI reflects the overhead or interference level for a given carrier. In the non-contiguous serving carrier scenario, in combination with the RSSI resource configuration (e.g., RMTC), MG, DRX cycle length and report period, the way of determining the RSSI measurement period T_{RSSI_measurement_period_inter_FC} may be as shown in Table 3-1 or 3-2:

TABLE 3-1

| Condition | T_{RSSI}_{_{—}}ₘₑₐₛᵤᵣₑₘₑₙₜ_{_{—}}_{period}_{_{—}}ᵢₙₜₑᵣ_{_{—}}_{FC} |
|---|---|
| No DRX | max(reportInterval_FC, max |
| | (rmtc- Periodicity_FC, MGRP) × CSSFᵢₙₜₑᵣ) |
| DRX | max(reportInterval_FC, max |
| | (rmtc- Periodicity_FC, MGRP, |
| | DRX cycle) × CSSFᵢₙₜₑᵣ) |

In Table 3, reportInterval_FC is a report interval under the FC scenario to indicate how long reporting is repeatedly triggered, and may be configured by the network, rmtc-Periodicity_FC is the RMTC period used for in-gap interference measurement, DRX cycle is the DRX cycle, and MGRP is related to at least one of the MG period, and optionally, may also be related to the number N_{intra-MO-FC} of measurement objects that may be measured intra-frequency when there is no measurement gap, where N_{intra-MO-FC} is a parameter that is taken into consideration for solving the problem of possible multi-MO measurement during intra-frequency in-gap RSSI measurement when the RMTC for in-gap measurement is not overlapped with the SMTC for serving carrier measurement.

TABLE 3-2

| Condition | T_{RSSI}_{_{—}}ₘₑₐₛᵤᵣₑₘₑₙₜ_{_{—}}_{period}_{_{—}}ᵢₙₜₑᵣ_{_{—}}_{FC} |
|---|---|
| No DRX | max(reportInterval_FC, |
| | measurement interval_FC × |
| | CSSFᵢₙₜₑᵣ) |
| DRX | max(reportInterval_FC, |
| | measurement interval_FC × |
| | CSSFᵢₙₜₑᵣ) |

ReportInterval_FC is a report interval under the FC scenario to indicate how long reporting is repeatedly triggered, and may be configured by the network, and measurement interval_FC is the measurement gap used for in-gap interference measurement, and is related to at least one of the RMTC period used for in-gap interference measurement, the DRX cycle, the MG period, and the number Nintra-MO-FC of measurement objects that may be measured intra-frequency when there is no measurement gap, where Nintra-MO-FC is a parameter that is taken into consideration for solving the problem of possible multi-MO measurement during intra-frequency in-gap RSSI measurement when the RMTC for in-gap measurement is not overlapped with the SMTC for serving carrier measurement. In an example, during RSSI measurement with a measurement gap, when the DRX cycle is taken into consideration, measurement interval_FC=max(rmtc-Periodicity_FC, MGRP, DRX cycle).

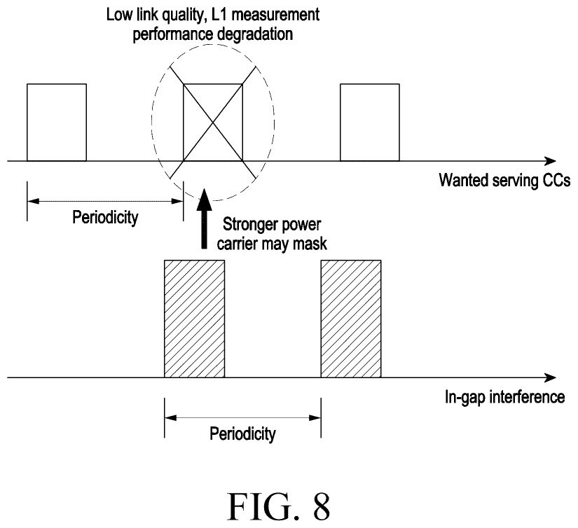

FIG. 8 is a schematic diagram of signal masking according to an embodiment of the disclosure.

In various embodiments of the disclosure, the interference measurement results may be reported no later than or during the measurement period for in-gap RSSI measurement.

In various embodiments of the disclosure, with regard to the above condition 3 (Th_enter_ingapfast, the second threshold Threshold A, the fifth threshold Threshold B/C), it is possible to enter the in-gap fast measurement mode and the serving cell extended measurement mode, specifically, the RSSI measurement or RSRP measurement with a small period based on the FC configuration and the serving carrier measurement with a long period considering unavailable/missing RS samples.

Optionally, the RRM measurement on wanted serving carriers may include intra-frequency or inter-frequency measurement, cell detection or the like., and may further include RLM, and Layer 1 measurement of BFD/candidate beam detection (CBD)/L1-RSRP/L1-SINR. Considering that the RRM measurement is multi-SMTC/SSB occasion (which may also be interpreted as multi-sample) measurement, the increase of the in-gap interference level may make the periodic RS events of serving cells unavailable temporarily during measurement. For example, referring to FIG. 8, when the UE performs neighbor cell measurement (e.g., in one measurement period) and serving cells are masked in certain measurement resources (SMTC), these masked measurement resources become invalid resources. Thus, the channel link quality of serving carriers will be inaccurate (e.g., the L1 measurement performance degrades), resulting in non-optimal beam management and unnecessary beam failure detection. Therefore, when the UE performs L1 filtering on the measurement values, this masked/missed transmission should not be regarded as low SS-RSRP. Accordingly, in the embodiments, for serving cell measurement, the RRM detection period (measurement period) may be extended (or prolonged) to incorporate enough valid resources to ensure accurate measurement results, and the DL performance is ensured to reach the acceptable maximum number of missing RSs on the basis of limiting the measurement delay.

In various embodiments of the disclosure, to realize the in-gap fast RSRP measurement (short measurement period) of the non-contiguous serving carrier configuration, the definition of the third measurement period for in-gap neighbor cell measurement may be related to at least one of:
(1) DRX: the DRX cycle may be ignored for fast measurement;
(2) reference signal period T_{RS}: it is the period of RSs transmitted on in-gap CCs;
(3) high measurement priority: the in-gap carrier specific scaling factor CSSF_{intra_ingap} is equal to 1; and
(4) in-gap carrier specific scaling factor CSSF_{intra_ingap}: when one in-gap CC and many intra-band SCCs are configured together, for in-gap CCs, CSSF_{intra_ingap} is equal to 1 or other predetermined scales, e.g., 50%.

Specifically, to ensure that the missing measurement resources on serving cells will not have a fatal impact on primary cell (PCell) connection and maintain the communication function of connected cells, in the embodiments of the disclosure, the following solution is taken into consideration.

For in-gap measurement, a priority criterion is taken into consideration for in-gap interference carriers. In the embodiments of the disclosure, a carrier specific scaling factor (in-gap CSSF) of the in-gap CC measurement is defined. The in-gap CSSF may be determined based on at least one of:
(1) the number of searchers related to band combinations of the first carrier and the second carrier (non-contiguous carriers);
(2) the proportion of resources occupied by each measured component carrier in the searchers; and
(3) the priority of each measured component carrier.

In various embodiments, a definition mode (mode 1) is provided for the in-gap CSSF: defining CSSF_{intra_ingap}=1, or defining an in-gap CC as the highest priority.

For example, based on the hypothesis of two searchers, one primary CC (PCC) has a dedicated searcher, while other SCCs (including non-contiguous SCCs and interference CCs) share one searcher. For bands configured by the network and a UE that supports the use of a Rx chain to receive non-contiguous serving carriers, if it is necessary to measure in-gap CC interference between two non-contiguous CCs, the CSSF of the interference CC is set to 1 or set to have the highest priority, so that its measurement is prior over other wanted SCCs.

In various embodiments, another definition mode (mode 2) is further provided for the in-gap CSSF.

For example, based on the hypothesis of two searchers, one PCC has a dedicated searcher, while other SCCs (including non-contiguous SCCs and interference CCs) share one searcher. For bands configured by the network and a UE that supports the use of a Rx chain to receive non-contiguous carriers, if it is necessary to measure in-gap CC interference between two non-contiguous CCs, the interference CC measurement is prior over other wanted SCCs and has a 50% measurement opportunity. As an example, the FR1 only CA scenario is as shown in Table 4:

TABLE 4

| CSSF of FR1 PCC | CSSF of FR1 interference SCC |
|---|---|
| 1 | 2*(Number of configured FR1 SCell(s) − 1) |

In various embodiments of the disclosure, another definition mode (mode 3) is further provided for the in-gap CSSF.

For example, based on the hypothesis of three searchers, one PCC has a dedicated searcher, while other wanted CCs share one searcher, and one interference CC has a dedicated searcher. As an example, the FR1 only CA scenario is as shown in Table 5:

TABLE 5

| CSSF of | CSSF of FR1 | |
|---|---|---|
| FR1 PCC | interference CC | CSSF of FR1 SCC |
| 1 | 1 | 2*(Number of configured FR1 SCell(s) − 1) |

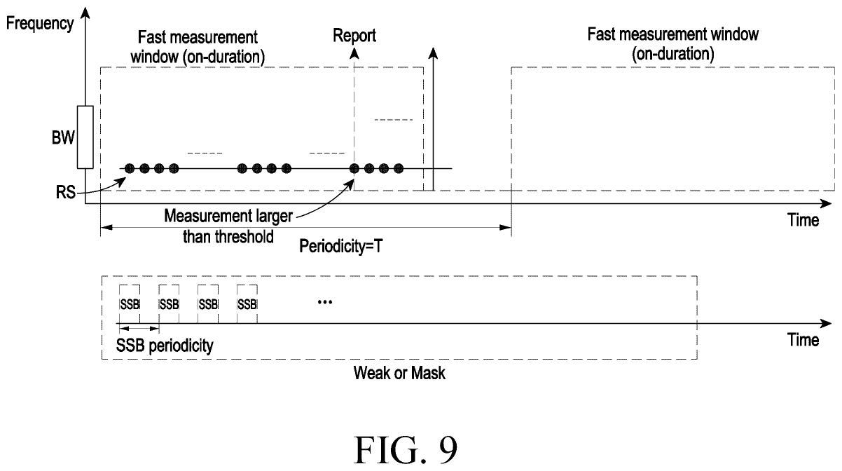

FIG. 9 is schematic diagram of a window-based in-gap neighbor cell measurement method according to an embodiment of the disclosure.

The advantage of defining the in-gap CSSF is to trigger separate Rx reception in time and track the signal quality or interference quality of in-gap CCs in real time.

In various embodiments of the disclosure, to realize the in-gap fast RSRP measurement (short measurement period) of the non-contiguous serving carrier configuration, another measurement period (fourth measurement period) definition mode is further provided for in-gap neighbor cell measurement, e.g., window-based fast RSRP measurement, which may also be referred to as one-shot fast RSRP measurement and corresponds to one additional measurement time window. In this time window, interference measurement resources may be provided.

The window may be defined as:
window length (T_{FMW}). That is, the duration of the fast measurement window is defined as min(Tᵣₑₚₒᵣₜ_{_{ingap}}, Tₘₑₐₛᵤᵣₑₘₑₙₜ_{_{ingap}}) where Tᵣₑₚₒᵣₜ_{_{ingap}} represents the duration from slot n+T_{processing} to in-gap RSRP measurement reporting, where T_{processing} is the processing time and the specific value of T_{processing} depends on the UE capability report; and, Tₘₑₐₛᵤᵣₑₘₑₙₜ_{_{ingap}} is the in-gap RSRP measurement period.

Referring to FIG. 9, for the UE's measurement behavior, till to slot n+T_{processing}+T_{FMW}, the UE measures configured in-gap reference signal resources. Specifically, for L1 measurement, the UE considers RS-based measurement. Optionally, the RS may be an SSB. For L3 measurement, the UE considers SMTC-based measurement, where there is a one-to-one mapping relationship between SMTCs and SSBs. In addition, T_{lower} is the measurement period lower bound, and depends on the UE capabilities.

In an example, the way of determining the measurement period (fourth measurement period) T_{RS_measurement_period_ingap} of in-gap neighbour cells may be as shown in Table 6:

TABLE 6

| FR | T_{RS}_{_{—}}ₘₑₐₛᵤᵣₑₘₑₙₜ_{_{—}}_{period}_{_{—}}_{ingap} |
|---|---|
| FR1 | ceil(M × Kₚ) × max(T_{lower}, T_{RS}) × CSSF_{ingap} |
| FR2 | ceil(M × K_{FR} × Kₚ × K_{layer1}_{_{—}}ₘₑₐₛᵤᵣₑₘₑₙₜ) × |
| | max(T_{lower}, T_{RS}) × CSSF_{ingap} |

In Table 6, M represents the total number of samples to be measured, and Kₓ is a scaling factor considering other configuration conflicts. Specifically, K_{layer1_measurement} is related to the conflicting/overlapping relationship between configured L1 and L3 measurement resources, Kₚ is related to the conflicting/overlapping relationship between configured SMTC and MG resources, K_{FR} is a relaxation factor depending on the band range and the SSB sub-carrier spacing (SCS), and CSSF_{ingap} is a CSSF used for in-gap RSRP measurement. Optionally, CSSF_{ingap}=CSSF_{intra_ingap}. The specific definition way may refer to the above description and will not be repeated here. T_{lower} is the measurement period lower bound, and T_{RS} is the RS period.

In various embodiments of the disclosure, in-gap fast RSSI measurement with a small period based on a new measurement granularity is further provided.

In various embodiments, the way of defining the fast measurement period for in-gap RSSI measurement may be as follows: the RSSI measurement period is determined by the new granularity related to in-gap measurement, the result report interval and the carrier specific scaling factor (e.g., CSSF_{intra_ingap}). The new granularity may replace the DRX cycle, and is related to at least one of: rmtc-Periodicity_FC (RMTC period), DRX cycle and MGP. Optionally, granularity=α(rmtc-Periodicity, DRX cycle, MGP), where α(⋅) is an operator and may be min(⋅) or of (⋅).

Optionally, the criterion of triggering fast measurement may include: (1) in-gap power RSRP>threshold B or in-gap interference level RSSI>threshold C; and (2) serving cell measurement RSRP<threshold A is continuously met in the evaluation period.

In various embodiments of the disclosure, an implementable way of UE triggering is provided. If the in-gap CC measurement result meets the criterion of triggering fast measurement, the UE reports an in-gap CC fast measurement result or event, and the NW sends an X1-bit (e.g., 1-bit) L1/L2 activation instruction (e.g., medium access control (MAC)-control element (CE)). Upon receiving this instruction, based on the RRM measurement resources configured by this instruction in the radio resource control (RRC) configuration, the UE performs (fast) measurement of in-gap CCs indicated by a carrier or cell indication index (e.g., Fragmentedcarriercell physical cell identifier (PCI)).

In various embodiments, the following two situations are taken into consideration for serving cell measurement.
1) The UE knows the transmission characteristics of reference signals (e.g., SSBs) on interference CCs (which may also be regarded as neighbor CCs at this time), including SSB measurement window. These prior information may be directly indicated by the network, and the UE may detect the existence of interference SSBs/CSI-RSs and perform measurement.
2) If the UE cannot know the prior indication of the in-gap signals/channels in advance, such as the spectrum from different operators, the uncertainty of transmission traffic, the uncertainty of channel access or based on busy data traffic, the UE cannot be expected to control the regular transmission of reference signals.

However, in any case, since it is necessary to perform measurement on interference CCs to obtain the reference signal power, this measurement also needs to be performed on multiple samples in a certain measurement window. However, in the “interference signal transmission” window (also referred to as in-gap) or one measurement period, the UE may lose some normally-transmitted Layer 1 (L1) measurement samples. To prevent missing L1 samples from affecting the measurement process (e.g., RRM measurement, L1 measurement, radio link monitor (RLM), or the like.) and accuracy, various embodiments provide an optimized measurement method. Depending on the availability of valid reference signals, considering unavailable or missing RS samples, the measurement period (fifth measurement period) of serving carriers is prolonged, and enough samples (Lₘᵢₛₛ) are provided on the basis of limiting the measurement delay. As an example, for L3 measurement, the measurement period is extended at least based on the number of SMTC occasions unavailable for synchronization signal detection in the detection period. However, the maximum value of the number of SMTC occasions unavailable for synchronization signal detection is related to the configured DRX cycle, to ensure downlink performance and accurate TCI switching based on the acceptable maximum number of missing RSs.

In various embodiments of the disclosure, the serving cell RSRP measurement period (fifth measurement period) is related to at least one of the allowable number of samples, the DRX cycle and the RS period. The allowable number of samples is defined as M+Lingap, where M is the number of original measurement samples, and Lingap represents the number of measurement occasions unavailable in the measurement period due to in-gap CC measurement and depends on at least one of: a DRX cycle configuration and an RS period configuration.

In an example, the detection period (fifth measurement period) T_{PSS/SSS_sync_intra_FC} of synchronization signals (e.g., primary synchronization signals (PSSs)/secondary synchronization signals (SSSs)) of FCs in the FR1 frequency range may be extended as shown in Table 7:

TABLE 7

| DRX cycle | T_{PSS/SSS}_{_{—}}_{sync}_{_{—}}ᵢₙₜᵣₐ_{_{—}}_{FC} |
|---|---|
| No DRX | ceil((5 + Lpss/sss) × Kₚ) × SMTC period × |
| | CSSFᵢₙₜᵣₐ_{_{—}}_{FC} |
| DRX | ceil((M2^{Note2} ×+ (5 + Lpss/sss) × Kₚ) × |
| cycle ≤ 320 ms | max(SMTC period, DRX cycle) × CSSFᵢₙₜᵣₐ_{_{—}}_{FC} |
| DRX | ceil((5 + Lpss/sss) × Kₚ) × DRX cycle × |
| cycle > 320 ms | CSSFᵢₙₜᵣₐ_{_{—}}_{FC} |

In Table 7, Kₚ is related to the conflicting/overlapping relationship between the configured SMTC and MG resources, SMTC period is the SMTC period, DRX cycle is the DRX cycle, and CSSF_{intra_FC} is the carrier specific scaling factor used for serving carrier measurement. Lpss/sss represents the number of SMTC occasions unavailable for synchronization signal detection in the detection period, and the value of Lpss/sss may vary depending on whether the DRX is configured.

Optionally, when no DRX is configured, the value of Lpss/sss is equal to the number of SMTC occasions unavailable for PSS/SSS detection in the detection period, where Lpss/sss<Lpss/sss,max.

When the DRX is configured, the value of Lpss/sss is affected by the DRX cycle, and for example, may include the number of at least one SMTC occasions unavailable for PSS/SSS detection in the detection period, where Lpss/sss<Lpss/sss,max.

Optionally, Lpss/sss,max is configured by the network.

In an example, for SSB-based L1-RSRP measurement, the L1-RSRP measurement period (fifth measurement period) T_{L1-RSRP_Measurement_Period_SSB_FC} in the FR1 may be extended as shown in Table 8:

TABLE 8

| Configuration | T_{L1-RSRP}_{_{—}}_{Measurement}_{_{—}}_{Period}_{_{—}}_{SSB}_{_{—}}_{FC} (ms) |
|---|---|
| No DRX | max(T_{Report}, ceil((M + Lingap)*P)*T_{RS}) |
| DRX cycle ≤ 320 ms | max(T_{Report}, ceil(K *(M + Lingap)*P) |
| | *max(T_{DRX}, T_{RS})) |
| DRX cycle > 320 ms | ceil((M + Lingap)*P)*T_{DRX} |

In Table 8, T_{Report} is the report period; M is the total number of samples to be measured; K may be 1 or 1.5 and is related to a high-layer configuration; P is related to the SSB resources to be measured when the measurement gap occasion is taken into consideration; T_{DRX} is the DRX cycle; T_{RS} is the RS period; and Lingap represents the number of SSB occasions unavailable in the measurement period, and the value of Lingap may vary depending on whether the DRX is configured.

For example, when no DRX is configured, Lingap is the number of SSB occasions unallowable in the L1-RSRP measurement period.

Situation 1: if the timeRestrictionForChannelMeasurement (the time limit for channel measurement) is configured, the measurement that has been performed on the L1-RSRP is based on one SSB occasion (or sample). At this time, Lingap=0. If the measurement resources on wanted CCs are masked, the UE has no resources for measurement. At this time, the UE may skip this reporting, or the UE reports “not valid” to indicate that no measurement resources or no enough measurement resources are received in the measurement period, so the NW waits for a next opportunity to send SSBs and may ignore this reporting and wait for valid reporting in a next period.

Situation 2: if no timeRestrictionForChannelMeasurement is configured and the DRX is 0, the L1-RSRP measurement is based on three SSB occasions (or samples). To obtain enough samples in the measurement period to meet the accuracy requirement, the measurement period needs to be extended, and Lingap is the number of SSBs unallowable on the UE side in T_{L1-RSRP_Measurement_Period_SSB_FC}. For Max(T_{DRX}, T_{RS})≤40 ms, Lingapmax=X1; and for non-DRX, T_{DRX}=0, where X1 is a non-zero integer configured by the network.

Situation 3: if no timeRestrictionForChannelMeasurement is configured, the DRX is not 0, it is necessary to define different Lingapmax according to different DRX cycles to avoid too large Lingapmax. This is because the BS may perform TCI switching based on the old channel quality information so as to lead to inaccurate TCI switching.

Lingapmax=X2 when 40 ms<max(T_{DRX}, T_{RS})≤320 ms; and

Lingapmax=X3 when T_{DRX}>320 ms,

where X2 and X3 are non-zero positive integers, and Lingap<=Lingapmax.

Various embodiments of the disclosure may be applied in a scenario where any one of two fragmented carriers is a PCell.

In an example, the extended RLM evaluation period may be defined, wherein the extended evaluation period is related to at least one of: a signal-to-noise ratio condition of reference signals for RLM, and the number of SSB occasions unavailable in the evaluation period in out-of-sync and in-sync situations, where the number of SSB occasions unavailable in the evaluation period is related to the configured DRX cycle.

In the traditional technology, the UE monitors the downlink channel quality of serving cells based on SSBs or CSI-RSs, and evaluates the downlink quality in each evaluation period. According to the prior art, if the downlink quality is lower than a threshold Qout in several consecutive periods, out of sync (OOS) is reported, and a timer is started for considering a radio link failure (RLF). However, at this time, since in-gap interference is at strong power, the UE will be prevented from using a fully shared Rx chain to receive measurements of multiple carriers, particularly wanted carriers. At this time, if the SSBs on wanted CCs are reference signals transmitted with weak power and when the interference SSBs are at strong power, normal SSB transmission will be blocked. At this time, some required RLM-RSs will be missed in out-of-sync and in-sync evaluation processes. The UE cannot distinguish whether missing SSB transmission on wanted CCs in that its own link quality is poor or RLM-RSs are blocked by interference SSBs. At this time, even if the wanted channel condition is good, the UE will still report an OOS indication to a higher layer, and this wrong result will lead to undesired RLF. However, if the wanted channel condition really becomes worse but the UE does not respond to the configured periodic RLM-RS resource, an unacceptable delay will still occur in reporting RLF. Thus, a new RLM measurement requirement needs to be defined to balance the probability of wrongly declaring RLM and the delay in declaring RLM. On this basis, the existing RLM evaluation period needs to be extended to compensate for the SSB occasion transmission loss caused by interference measurement. Under different DRX cycles or SSB periods, the evaluation periods T_{Evaluate_out_SSB,FC} and T_{Evaluate_in_SSB,FC} may be different, as shown in Table 9.

TABLE 9

| | T_{Evaluate}_{_{—}}ₒᵤₜ_{_{—}}_{SSB, FC} (ms) | | |
|---|---|---|---|
| | RLM-RS RS | RLM-RS RS | |
| Configuration | Es/Iot ≥− X dB | Es/Iot^{Note4} <− X dB | T_{Evaluate}_{_{—}}ᵢₙ_{_{—}}_{SSB}_{_{—}}_{FC} (ms) |
| No | Max(200, Ceil((Y1 + | Max(200, Ceil((Y4 + | Max(100, Ceil((5 + |
| DRX | Lₒᵤₜ) × P) × T_{RS}) | Lₒᵤₜ) P) × T_{RS}) | Lᵢₙ) × P) × T_{RS}) |
| DRX | Max(200, Ceil((Y2 + | Max(200, Ceil(1.5 × | Max(100, Ceil((7.5 + |
| cycle ≤ | Lₒᵤₜ) × P) × | ((Y5 + Lₒᵤₜ) × | Lᵢₙ) × P) × |
| 320 | Max(T_{DRX}, T_{RS})) | P) × Max (T_{DRX}, T_{RS})) | Max(T_{DRX}, T_{RS})) |
| DRX | Ceil((Y3 + Lₒᵤₜ) × | Ceil((Y6 + Lₒᵤₜ) × | Ceil((5 + Lᵢₙ) × |
| cycle > | P) × T_{DRX} | P) × T_{DRX} | P) × T_{DRX} |
| 320 | | | |

In table 9, P is related to the RLM-reference signal resources to be measured when the measurement gap occasion is taken into consideration; T_{DRX} is the DRX cycle; T_{RS} is the RS period; and Lₒᵤₜ and Lᵢₙ are the numbers of SSB occasions unavailable at the UE due to in-gap interference measurement in out-of-sync and in-sync situations, respectively, or may be described as the numbers of L1 samples unavailable in the evaluation period. Y1 to Y6 are the numbers of required basic SSB occasions (or the numbers of samples), and are fixed values. −X may measure the signal to interference plus noise ratio (SINR) or SNR. If the SINR/SNR is smaller, the number of required basic samples is larger. Lₒᵤₜ≥0. In particular, when the DRX is not 0, Lₘₐₓ needs to be taken into consideration. Lₒᵤₜ<Lₘₐₓ. This is because the OOS is always not indicated when the UE often fails to detect the configured RLM-RS resource to lead to an unacceptable delay in declaring RLF. Lₘₐₓ is also at least related to the DRX cycle. Optionally, the RSs may be SSBs.

In combination with the above at least one embodiment, after the first measurement result (the measurement results of serving cells) and the second measurement result (the measurement result of the in-gap signal between non-contiguous serving carriers) are obtained, based on at least one of the first measurement result, the second measurement result and the switching condition (the triggering condition of enabling the second receiving mode), the UE determines whether to use a separate RF chain to receive non-contiguous serving carriers.

In various embodiments of the disclosure, the switching condition is related to at least one of:
(1) first carrier aggregation reconfiguration information being received;
(2) the first measurement result being smaller than a third threshold in a first evaluation duration, and the second measurement result of measuring the third carrier being larger than a fourth threshold in a second evaluation duration, wherein the first evaluation duration and the second evaluation duration are values configured by a network node or predefined, and the evaluation duration may also be referred to as evaluation duration or evaluation period; and
(3) a power spectral density (PSD) difference between the second measurement result and the carrier with lowest PSD in the non-contiguous serving carriers.

The switching condition may correspond to a condition 4 (Th_enter_Separate Rx chain). In an example, the condition 4 may be related to at least one of the serving cell measurement quantity RSRP, the serving cell measurement SINR and the in-gap signal strength RSSI/RSRP, and may be represented as for example, serving cell: RSRP<Threshold A′, in-gap: RSRP>Threshold B′, RSSI>Threshold C′; or, serving cell: SINR<Qout, in-gap: RSRP>Threshold B′, RSSI>Threshold C′, where Threshold A′ and Qout represent the third threshold, and Threshold B′ and Threshold C′ represent the fourth threshold. The condition 4 indicates that the serving cell channel quality is poor and the interference effect is larger.

If the triggering condition is met after the evaluation period, with or without an X2-bit indication, the UE reports a separate RF chain mode related event. Based on the report result, the NW performs a new CA configuration (first carrier aggregation reconfiguration information) with carrier release. Upon receiving the new CA configuration and after a switching interruption, the UE falls back to the separate RF chain receiving mode to measure non-contiguous serving carriers and perform data reception. The switching interruption event is related to the RF re-tuning time.

When the RSRP measurement results of the first carrier and the second carrier (non-contiguous carriers) are smaller than the third threshold in the first evaluation duration, the third threshold is related to an RSRP threshold. When the downlink received SINR performance of the first carrier and the second carrier is smaller than the third threshold in the first evaluation duration, the third threshold is related to a radio link monitor out-of-sync threshold.

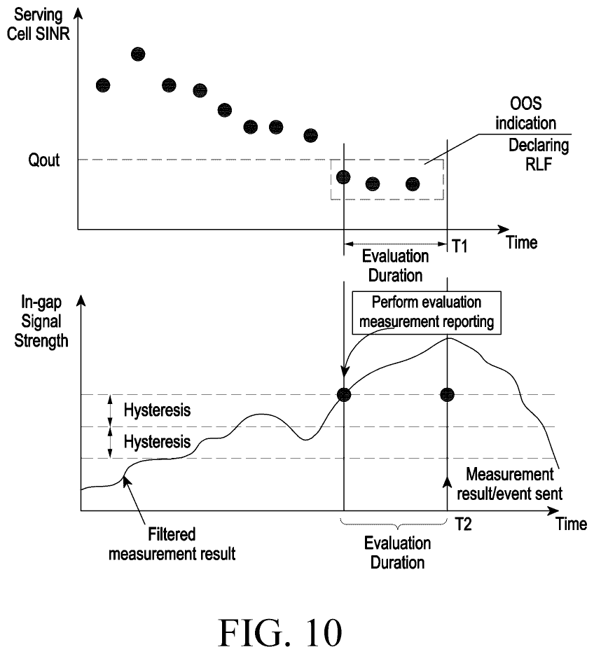

FIG. 10 is a schematic diagram of a triggering condition of entering the second receiving mode according to an embodiment of the disclosure.

Referring to FIG. 10, the condition 4 (Th_enter_Separate Rx chain) may include:
(1) the serving cell channel quality in the evaluation period (the first evaluation duration; T1 in FIG. 10 is the upper bound of the evaluation period) is low enough (e.g., smaller than −112 dB); and
(2) due to low SINR, the missing RS occasion is evaluated as a sample triggering OOS, and the channel condition of in-gap CCs in the evaluation period (the second evaluation duration; T2 in FIG. 10 is the upper bound of the evaluation period) is good (e.g., larger than or equal to −95 dBm).

The relationship between T1 and T2 may be as follows:
if T1=T2, the OOS or separate RF chain reception event is reported and separate RF chain reception is triggered with or without an X2-bit indication;
if T1<T2, the OOS is reported and separate RF chain reception is triggered with or without an X2-bit indication; and
if T1>T2, the separate RF chain reception event is reported and separate RF chain reception is triggered with or without an X2-bit indication.

When the switching condition is met, after a first interruption length, the first receiving mode is switched to a second receiving mode to receive the first carrier and the second carrier (non-contiguous carriers from a same band).

In various embodiments of the disclosure, the UE may also send, to a network node, UE assistance information (UAI) used for at least requesting the network node to reconfigure carrier aggregation, receive second carrier aggregation reconfiguration information from the network node, and switch, based on the second carrier aggregation reconfiguration information, from the first receiving mode to the second receiving mode to receive the first carrier and the second carrier (non-contiguous serving carriers from a same band).

Several examples of the switching mode from the first receiving mode to the second receiving mode are given below.

Switching mode 1: when a new CA configuration (first carrier aggregation reconfiguration information) is received, after an interruption (first interruption window/length), the UE falls back to the RF second receiving mode to measure serving carriers or back to a non-CA mode.

Switching mode 2: a PSD difference between the unwanted signal and the wanted carrier with lowest PSD (also referred to as the wanted signal requiring lower PSD) in the wanted carriers is determined; and, based on the PSD difference and the corresponding threshold, it is determined whether the switching condition between the RF first receiving mode and the RF second receiving mode is met.

The PSD difference may also be described as:
   |X_{unwanted carrier/interference psd}−Y_{wanted carrier lower psd}|, e.g., the difference between the power of the interference carrier and the power of the wanted carrier requiring lower PSD. Optionally, if |X−Y|<Pre-configured threshold1 dBm, the UE may support non-contiguous serving carriers through the RF first receiving mode.

Switching mode 3: by taking absolute RSRP measurement as an example, the in-gap signal power may be directly measured to define a mapping table. If value₀ to valueₙ are used for representing different reported values and correspond to different in-gap interference measurement quality ranges, the difference between the maximum value and the maximum value of each measurement quality range is 1 dBm. If the in-gap RSRP value is in a certain range, the reported value may correspond to “not valid”, meaning that the UE may support non-contiguous serving carriers through the RF first receiving mode, and may also instruct the NW to allow for scheduling more serving carriers. If the in-gap RSRP value is in other ranges, the reported value may correspond to the corresponding formal measurement quantity. It means that the in-gap interference signal power level is so high that the UE may no longer support existing non-contiguous serving carriers by using the RF first receiving mode.

Switching mode 4: the UE may send, to a network node, UAI used for at least requesting the network node to reconfigure CA, and switch from the RF first receiving mode to the RF second receiving mode to receive at least two non-contiguous serving carriers from a same band (e.g., a same operator).

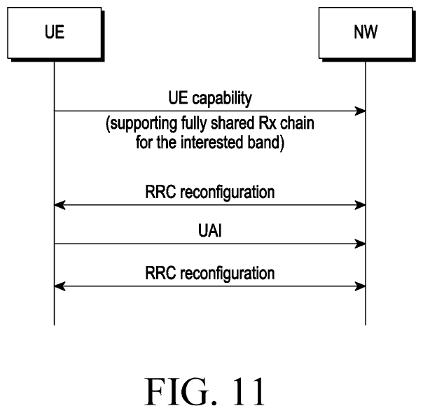

FIG. 11 is a schematic diagram of UAI information transmission according to an embodiment of the disclosure.

In various embodiments of the disclosure, for a UE that supports the first capability for a specific band or CA configuration and is using the RF first receiving mode to measure non-contiguous CCs, for the purpose of power saving/overheating or other UE demands, the UE may be allowed to send NR UAI (e.g., overheating related tendency) to the network in some particular circumstances to exit the RF first receiving mode for receiving, and fall back to a separate Rx chain or partially shared Rx chain to receive non-contiguous serving carriers. The UAI may be sent after a radio resource control (RRC) reconfiguration to request the NW to reconfigure parameters. According to the UAI, the NW may reconfigure CA or do nothing, referring to FIG. 11.

Optionally, the switching modes 1, 2, 3 and 4 described above may be combined as switching conditions or may also be used as switching conditions alone, which will not limited in the embodiments of the disclosure. In the first three modes, it is determined whether to switch the Rx chain structure according to the result of comparison of the measurement and the threshold, while in the fourth mode, the network assistance information is reported according to the UE's tendency, without measurement.

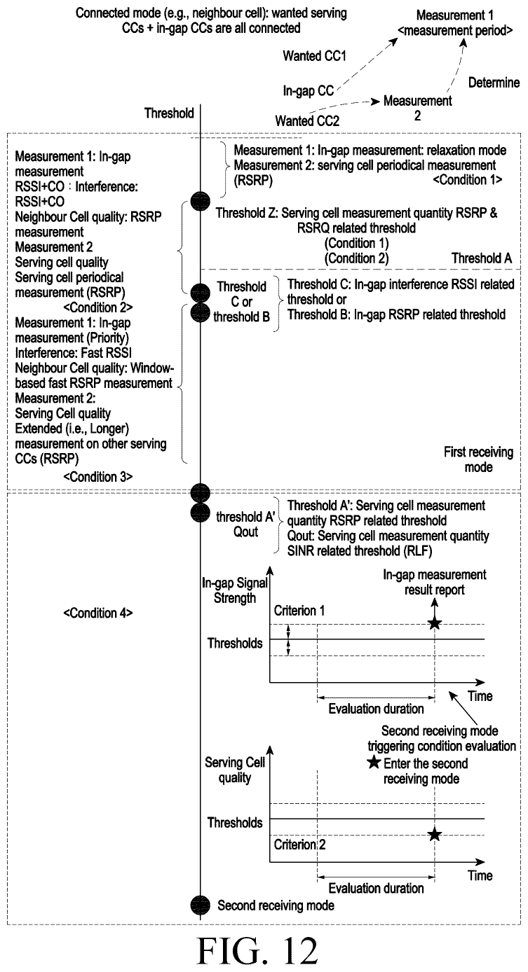

FIG. 12 is a schematic diagram of a dynamic measurement scenario according to an embodiment of the disclosure.

Based on the above at least one embodiment, a measurement scenario is provided in various embodiments of the disclosure, referring to FIG. 12.

(1) With Regard to in-Gap Measurement Relaxed Mode (Relaxed Measurement Period)

Measurement 1: During the periodic measurement of serving cells in a same band (serving cells in a same operator), if the RSRP/RSRQ-based measurement 1 meets the condition 1, the UE performs relaxed in-gap measurement based on a relaxation factor. Optionally, the measurement may include: SSB-less measurement of the activated serving carrier CC2 or SSB based measurement of serving carriers CC1 and CC2.

(2) With Regard to Normal in-Gap Measurement Mode (Legacy Measurement Period)

Measurement 1: During the periodic measurement of serving cells in a same band (serving cells in a same operator), if the RSRP/RSRQ-based measurement 1 meets the condition 2, the UE performs normal in-gap measurement based on a measurement reference signal (e.g., SSB) or RMTC. The in-gap interference operation may include channel occupancy indication and RMTC-based RSSI measurement, and the in-gap neighbor cell operation may include RSRP measurement based on the measurement reference signal.

(3) Fast in-Gap Measurement Mode and Extended Serving Cell Measurement
Measurement 1: periodic measurement of serving cells in a same band; and
Measurement 2: in-gap interference measurement.

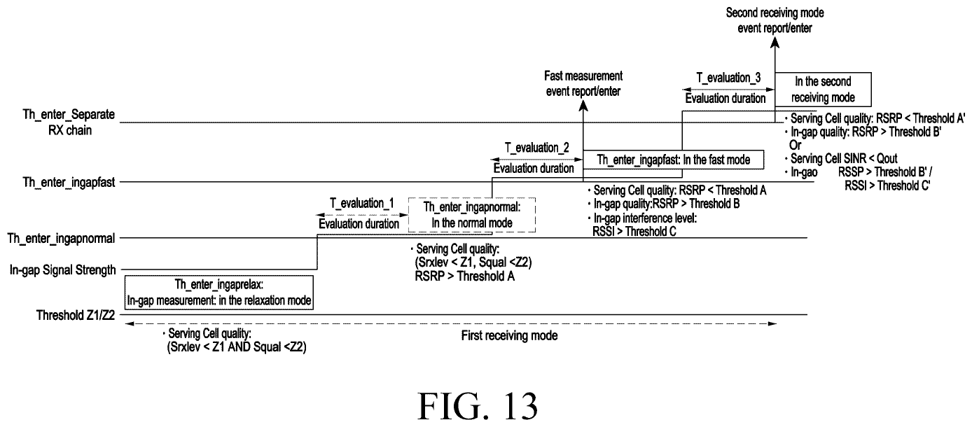

FIG. 13 is a schematic diagram of the details of a measurement mode according to an embodiment of the disclosure.

If the RSRP-based measurement 1 and the RSSI-based measurement 2 meet the condition 3, the UE will perform fast in-gap measurement and extended serving cell measurement. Wherein:

The fast in-gap measurement is fast in-gap interference measurement based on a new granularity, or fast in-gap neighbor cell RSRP measurement based on an in-gap CSSF parameter. Long measurement on serving carriers with unavailable/missing RS samples is taken into consideration.

If the serving cell measurement quantity RSRP/SINR and the in-gap signal strength meet the condition 4 in the evaluation period, the RF second receiving mode is triggered at this time.

Optionally, the in-gap measurement mode provided in various embodiments of the disclosure is shown in FIG. 13 and Table 10.

TABLE 10

| Considered | | |
|---|---|---|
| downlink | | |
| signal | In-gap measurement | |
| strength | mode | Condition |
| Serving cell: | RF first receiving mode | Condition 1: |
| RSRP/RSRQ | Relaxed measurement | Th_enter_ingaprelax, |
| level | mode based on relaxation | threshold Z1/Z2 |
| | factor | Serving cell: Srxlev_FC > |
| | | Z1 and Squal_FC > Z2 |
| Serving cell: | RF first receiving mode | Condition 2: |
| RSRP/RSRQ | Measurement mode based | Th_enter_ingaprelax, |
| level | on legacy period | threshold Z1/Z2 |
| | | Serving cell: RSRP < Z1, |
| | | RSRQ < Z2 and RSRP > |
| | | Threshold A |
| Serving cell: | RF first receiving mode | Condition 3: |
| RSRP level | Fast RSSI/RSRP | Th_enter_ingapfast, |
| In-gap: | measurement mode with | threshold A, Threshold |
| interference | small period | B/C |
| RSSI; or RSRP | | Serving cell: |
| | | RSRP < Threshold A |
| | | In-gap quality: |
| | | RSRP > Threshold B or |
| | | In-gap interference level: |
| | | RSSI > Threshold C |
| Serving cell: | RF second receiving | Condition 4: |
| RSRP level | mode | Th_enter_Separate Rx |
| or SINR | | chain |
| In-gap: | | Serving cell: |
| interference | | RSRP < Threshold A′ |
| RSSI; or RSRP | | In-gap: |
| | | RSRP > Threshold B′/ |
| | | RSSI > Threshold C′ |
| | | or |
| | | Serving cell: SINR < Qout |
| | | In-gap: |
| | | RSRP > Threshold B′/ |
| | | RSSI > Threshold C′ |

Srxlev_FC represents the serving cell received signal strength measurement related to fragmented carriers, and Squal_FC represents the serving cell received signal quality measurement related to fragmented carriers. Srxlev_FC is related to the RSRP measurement of serving cells in the fragmented carrier scenario, and Squal_FC is related to the RSRQ measurement of serving cells in the fragmented carrier scenario.

In various embodiments of the disclosure, to ensure the feasibility of using the RF first receiving mode to measure in-gap signals between two non-contiguous serving carriers from a same band (e.g., a same operator) and define the subsequent switching conditions, for a particular combination of CA bands, the UE reports a new capability of supporting non-contiguous serving carriers with the “first receiving mode”. Optionally, the UE reports information related to the first capability to the network node. Based on the report of the UE capability, the NE performs CA configuration with the non-contiguous serving carrier operation, in-gap signal measurement and reporting configuration.

Optionally, with regard to the UE capability, explicit UE capability signaling #X for supporting more CCs in the combination of non-contiguous CA with an RF chain is defined in the embodiments of the disclosure, where #X may include the PSD difference, MRTD and frequency span.

Optionally, with regard to the fragmented carrier related configuration and the in-gap neighbor carriers, an additional measurement identifier (measID) linked to MeasObject NR (for measurement) and ReportConfig NR (for reporting) is defined.

Specifically, in the embodiments of the disclosure, the explicit UE capability signaling #X is introduced to support the RF first receiving mode to accompany more carriers and/or more multiple-input multiple-output (MIMO) layers in a combination of non-contiguous CA bands.

For the supported particular band, the UE may report the information related to the first capability to the network node, for example, indicating to the network that it supports the first capability through capability signaling #X including the information related to the first capability.

Optionally, the information related to the first capability (capability signaling #X) may include at least one of:
(1) RF requirement parameters related to band combinations of the first carrier and the second carrier (non-contiguous carriers), where the RF requirement may include at least one of: power imbalance requirement, reception timing difference (RTD) requirement, the PSD difference between in-gap signal strength and the serving carrier with lowest PSD in at least two non-contiguous serving carriers, adjacent channel leakage ratio (ACLR), maximum permissible error (MPR), reference sensitivity power level (REFSENS), adjacent channel selectivity (ACS)/in-band blocking (IBB), supported maximum number of MIMO layers, or the like.;
(2) RRM requirement parameters related to band combinations of the first carrier and the second carrier (non-contiguous carriers), where the MRTD or maximum transmitting timing difference (MTTD) between non-contiguous serving carriers is co-located; and
(3) information related to a frequency span of the first carrier and the second carrier (non-contiguous carriers), also referred to as additional indication information, including a frequency span of two non-contiguous serving carriers.

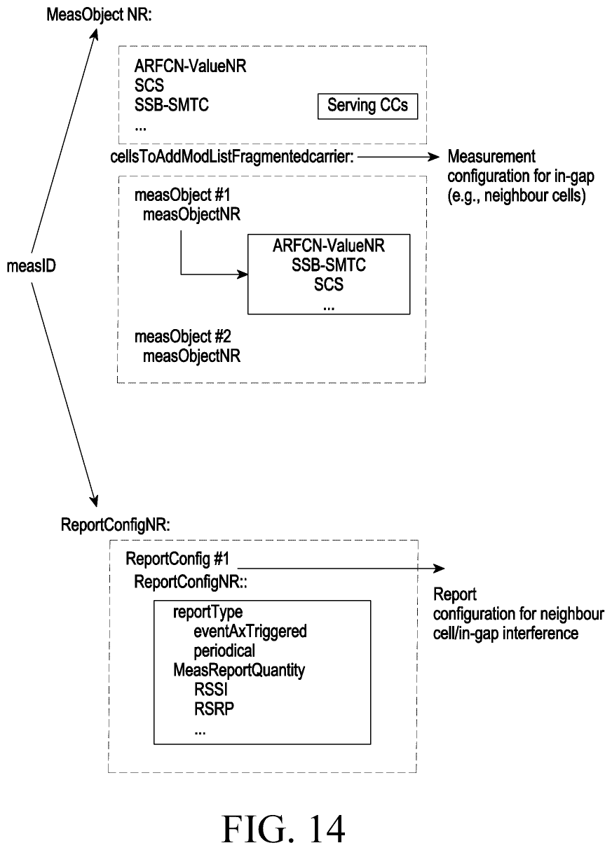

In various embodiments of the disclosure, after the information related to the first capability is reported, the received measurement configuration information may include first information related to in-gap interference RSSI measurement and in-gap neighbor cell RSRP or RSRQ measurement. Optionally, the NW configuration may be as shown in FIG. 14.

FIG. 14 is a schematic diagram of a network configuration supporting the use of the first receiving mode according to an embodiment of the disclosure.

By taking a neighbor cell configuration as an example, the reporting and measurement configuration may be interpreted as follows:
the measID of each neighbor cell is linked to one MeasObject NR (for measurement) and one ReportConfig NR (for reporting), wherein:

The parameter CellsToAddModListFragmentedcarrier may be interpreted as a list of neighbor cells to be added between two non-contiguous serving carriers, where each cell corresponds to one measurement object (MO).

The parameter MeasReportQuantity/ReportType in ReportConfigNR may be interpreted as reporting neighbor cell measurement results based on MOs, where the reporting trigger rule may include at least one of: periodic reporting, and reporting based on a first event (event Ax) related to non-contiguous serving carrier measurement. The RSRP/RSSI measurement values reported in the periodically triggered measurement reporting mode need to meet the accuracy requirement. The NW may configure the report period. Optionally, event Ax reporting may be taken into consideration.

Optionally, the parameter eventAxTriggered is interpreted as: an event Ax reporting configuration, where the event Ax is an existing event or a newly defined event.

As an example, the first event Ax may include a first event Ax entering condition and a first event Ax exiting condition; and, the first event Ax entering condition and the first event Ax exiting condition include at least one of: in-gap interference measurement results, in-gap neighbor cell measurement results, and thresholds configured by the network. The thresholds are related to the selected trigger measurement quantity, and the selected trigger measurement quantity may include at least one of: in-gap RSSI measurement, in-gap absolute RSRP measurement, in-gap absolute RSRQ measurement, and intra-band signal to interference ratio (SIR) measurement.

As an example, for first event Ax triggered reporting, Event Ax is defined as follows: in the evaluation period, the in-gap interference power becomes better than the threshold.
1> When A1-2 (e.g., inequation Ms+Hys<Pre-configured threshold) is met, it is considered that the first event entering condition is met.
2> When A1-1 (e.g., inequation Ms−Hys>Pre-configured threshold) is met, it is considered that the first event exiting condition is met.

Ms is the in-gap interference measurement result. The measurement quantity may be RSRP and/or RSSI and/or RSRQ and/or SIR, or the like. Hys is a hysteresis factor of the first event. Pre-configured threshold is an event threshold parameter configured by the network, and may be the same as or different from the fourth threshold.

Optionally, provided that the reporting criteria A1-1 and A1-2 are not met, the UE will not send any event triggered measurement report.

In various embodiments of the disclosure, for a UE that supports the first capability, in the FC scenario, a fully shared Rx chain may be used preferentially or by default to receive at least two non-contiguous serving carriers from a same operator. There is at least one following advantage.
1. Since more non-contiguous CCs may be received simultaneously, the possibility of aggregating more carriers in the future is provided.
2. The spectrum efficiency and system capacity may be improved by simultaneously processing more sub-carriers.
3. The additional DL MIMO layer (diversity) capability is provided in the case of the same number of Rx chain structures.

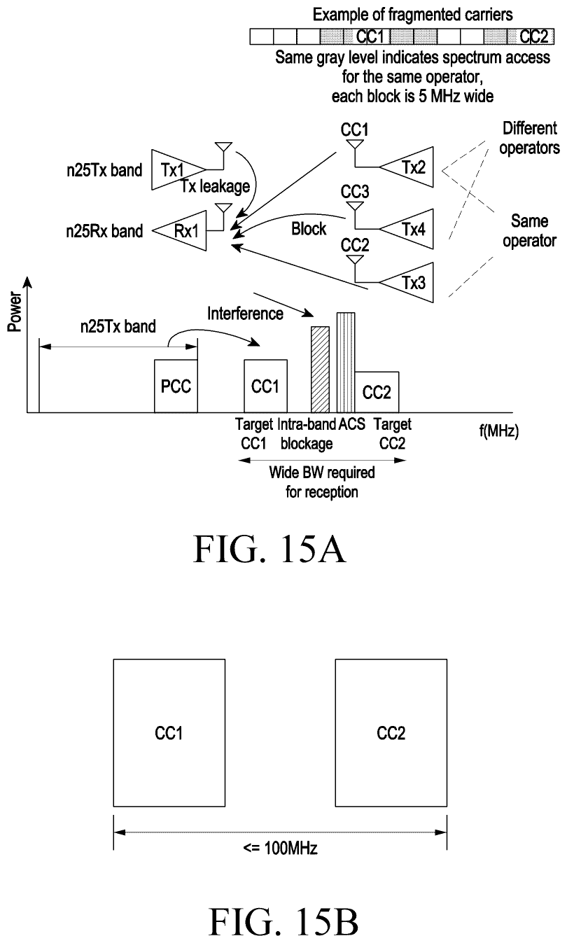

FIG. 15A is a schematic diagram of in-gap interference from different operators according to an embodiment of the disclosure.

FIG. 15B is a schematic diagram of a frequency span of two non-contiguous CCs according to an embodiment of the disclosure.

Meanwhile, considering that a fully shared Rx chain is used to receive at least two non-contiguous serving carriers from a same operator (also referred to as intra-operator), the in-gap interference from different operators (e.g., adjacent operators) may hinder the aggregation of target carriers, referring to FIG. 15A. The ACS is used to measure the receiver's capability of receiving wanted signals on the specified channel frequency when there are adjacent channel signals. Due to the use of the shared LPF, the in-gap interference between non-contiguous CCs cannot be effectively filtered, resulting in the performance reduction of target carriers. Accordingly, in the above at least one embodiment, by receiving the in-gap measurement and reporting measurement configuration information and performing corresponding measurement and reporting, this problem may be solved.

Optionally, ReportConfigNR may include parameters related to in-gap interference related RSSI measurement (for example, but not limited to, RMTC period for in-gap interference measurement, RMTC subcarrier offset, measurement duration in which the UE performs measurement, measurement gap suitable for FC RMTC measurement, or the like.).

In various embodiments, the RSSI is the total energy (e.g., signal strength, which may include, for example, serving cells and neighbor cells (from a same operator or different operators), and may also include signals, interference, noise, or the like.) measured by the UE in a given bandwidth (which may also be a specified band), for example, including a linear average of the total received power (in unit of [W]) according to the configured orthogonal frequency division multiplexing (OFDM) symbols and the measurement bandwidth indicated by a higher layer or the defined channel bandwidth. Reporting RSSI is an optional UE capability.

According to the definition of RSSI, the measured RSSI value is based on one measurement bandwidth. In other words, the RSSI value measured by the UE using larger bandwidth (or more PRBs) is higher than the RSSI value measured using smaller bandwidth (or less PRBs) even though the measured channel is the same. The RMTC configures the UE to perform measurement in a particular time resource, and may be configured by the NW to completely skip an SSB burst or SMTC.

The signal strength measured in the given bandwidth may include the signal strength received by nodes belonging to a same operator plus the interference from other nodes, where the other nodes include nodes belonging to other operators and/or nodes of other radio access technologies (RATs). The interference will increase the interference level. Since the signal strength received by nodes belonging to a same operator may be directly measured by the UE from all neighbor cells that are monitored by the UE, the strength of interference signals may be obtained from the RSSI and related signal energy measurement. Thus, the interference measurement results (second measurement result) from other operators may be obtained.

In various embodiments, the measurement configuration information may further include: a fourth threshold for determining whether the switching condition between a fully shared Rx chain and a separate Rx chain is met. For example, the fourth threshold (e.g., threshold threshS-RSSI-FC) related to the RSSI in the FC scenario is configured by the NW.

Optionally, the fourth threshold for RSSI is a non-zero integer.

Optionally, defining the fourth threshold for RSSI may include: defining an RSSI threshold for determining the contribution of sub-bands to in-gap measurement and inter-serving carrier SSB measurement (which may also be interpreted as the proportion of interference). Value 0 corresponds to −X dBm, value n corresponds to (−X+n×2) dBm, and so on, where −X represents a configurable threshold lower limit, and 2 represents an RSSI change gradient.

Or optionally, the fourth threshold for RSSI may also be universally defined as one threshold, e.g., −Y dBm.

In various embodiments of the disclosure, the RSSI reporting mode may be a dBm measurement value.

In various embodiments of the disclosure, after switching to the second receiving mode, the method may further include receiving third carrier aggregation reconfiguration information; and switching, based on the third carrier aggregation reconfiguration information, from the second receiving mode to the first receiving mode to receive the first carrier and the second carrier (non-contiguous carriers from a same band).

For example, after switching to the second receiving mode, if the NW sends new BS signaling through an RRC to indicate whether there is a non-contiguous serving carrier operation driven by the scenario and requirement or according to the operator requirement or data traffic, the network performs the CA configuration (third carrier aggregation reconfiguration information) again to indicate to the UE that there are more CCs to be aggregated (carrier aggregation configuration related information). If the switching condition of using the first receiving mode (which may be similar to at least one switching condition described above) is met, the UE may use a fully shared Rx chain to process non-contiguous serving carriers.

In various embodiments of the disclosure, after a first preset gap of switching from the first receiving mode to the second receiving mode, the second switching mode is used to receive at least two non-contiguous serving carriers from a same band.

After a second preset gap of switching from the second receiving mode to the first receiving mode, the first switching mode is used to receive at least two non-contiguous serving carriers from a same operator.

That is, an additional time (e.g., switching delay) is required for switching between the first receiving mode and the second receiving mode. This time may include an RF hardware preparation time. Since an additional RF switch is required, the related normal measurement will be interrupted. The interruption length may be 5 ms at most.

The technical solutions provided in the embodiments of the disclosure may be applied in the following scenarios:
1. n2/n25, n3, n7, n66, n41, n39 and other instance bands;
2. the frequency span including two non-contiguous CCs is smaller than or equal to 100 MHz, referring to FIG. 15B; and
3. in the case of using the first receiving mode to receive at least two CCs, the at least two CCs have the same sub-carrier spacing (SCS).

In the technical solutions provided in the embodiments of the disclosure, no complex signal processing algorithm is needed, thus avoiding the increase in the power consumption and cost of the UE and ensuring the sensitivity and selectivity of the receiver.

Based on the above at least one embodiment, an embodiment of the disclosure provides a complete receiving mode switching process.

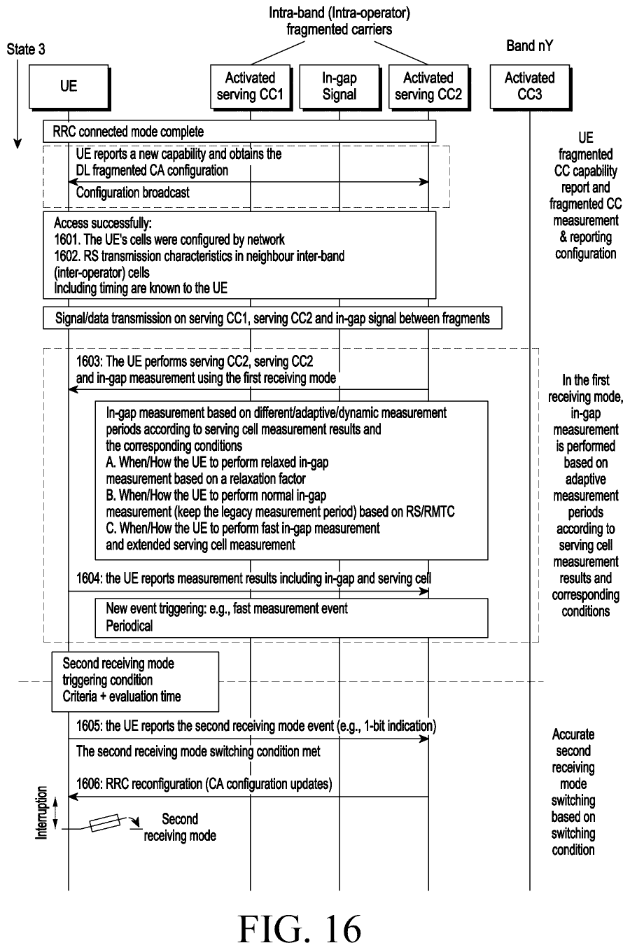

FIG. 16 is a schematic diagram of a complete receiving mode switching process according to an embodiment of the disclosure.

Referring to FIG. 16, the process may include the following operations.

At operations 1601 and 1602, the UE reports a new capability and obtains configuration information including measurement and reporting.

The new capability means that, for a CA configuration with a non-contiguous serving carrier operation, the UE supports an RF first receiving mode for receiving.

At operation 1603, based on serving cell measurement results and corresponding conditions, the UE adaptively performs in-gap measurement by using different measurement periods.

If the condition 1 based on the measurement quantity RSRP/RSRQ of the activated serving cell is met, the UE performs relaxed in-gap measurement (relaxed measurement period) based on a relaxation factor.

If the condition 2 based on the measurement quantity RSRP/RSRQ of the activated serving cell is met, the UE performs normal in-gap measurement based on the legacy measurement period.

If the condition 3 based on the measurement quantity RSRP of the activated serving cell and the in-gap interference RSSI measurement is met and if the criterion 3 related to the condition 3 in the evaluation period is met, the UE reports fast in-gap measurement, and the UE performs fast in-gap measurement and extended serving cell measurement (longer measurement period).

At operation 1604, based on event triggering or periodicity, the UE reports the measurement results including in-gap measurement and serving cell measurement.

At operation 1605, according to the triggering condition of closing the RF first receiving mode, the UE decides whether to use an RF second receiving mode to receive non-contiguous serving carriers and reports the corresponding event (indicated to the network).

At operation 1606, upon receiving a new CA configuration and after an interruption, the UE falls back to the RF second receiving mode to measure serving carriers or back to the non-CA mode.

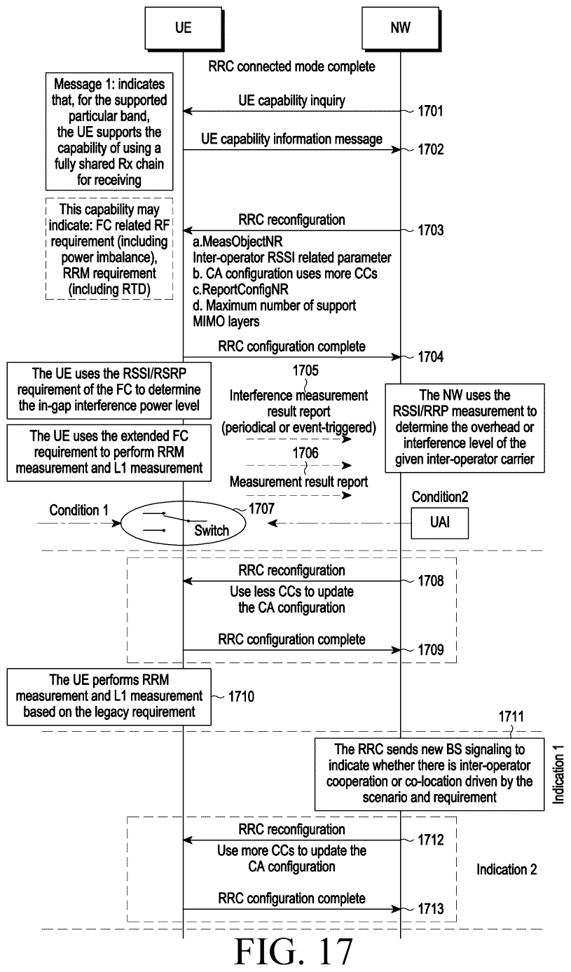

FIG. 17 is a schematic diagram of a complete Rx chain switching process according to an embodiment of the disclosure.

Based on the above at least one embodiment, in the embodiments of the disclosure, by taking the deploying of inter-operator scenario, FDD band co-located non-contiguous CA operation and DL range frequency span within 100 MHz as an example, a complete Rx chain switching process is provided. Referring to FIG. 17, the process may include the following operations.

At operation 1701, the NW initiates a capability inquiry to the UE.

At operation 1702, UE capability reporting is performed.

Optionally, the capability signaling design may include at least one of: non-contiguous CC RF requirement, e.g., ACLR, MPR, power imbalance, PSD difference, or the like.; and RRM requirement, e.g., RTD, or the like.

Optionally, the UE may report, through the capability signaling, to the network that it supports the CA configuration of a fully shared Rx chain architecture. Or it is indicated that it supports a fully shared Rx chain architecture for receiving for the supported particular band.

At operation 1703, RRC configuration/reconfiguration is performed.

Optionally, according to the capability reported by the UE, the network at least performs the CA configuration, inter-operator RSSI measurement related configuration and configuration required for reporting.

Optionally, the CA configuration indicates to the UE that there are more CCs to be aggregated.

Optionally, the NW needs to configure the inter-operator RSSI measurement related configuration in the MeasObjectNR. This configuration may include at least one of: threshold threshS-RSSI-FC, RMTC period for in-gap measurement, RMTC sub-carrier offset, measurement duration in which the UE performs measurement, and measurement gap suitable for FC RMTC measurement.

Optionally, the NW configures the configuration required for reporting in the ReportConfigNR. This configuration may include at least one of: report type, report period, and report triggering event.

Optionally, the NW configures the maximum number of supported MIMO layers, which is 8 at most.

At operation 1704, the RRC configuration is completed.

At operation 1705 and 1706, according to measurement resources and in the TDM mode, the UE measures the RSSI based on the measurement period for non-contiguous serving carrier RSSI measurement respectively to obtain the in-gap interference level and performs Layer 3 (RRM measurement) and/or Layer 1 measurement or detection based on the extended measurement period or detection period for non-contiguous serving carrier measurement, e.g., cell detection, L1-RSRP measurement and RLM evaluation. After the measurement is completed in the specified measurement period, the UE reports the in-gap interference measurement result periodically or in an event triggering manner.

Other measurement quantities may be at least one of RSRP, RSRQ and SINR.

Optionally, the measurement period for non-contiguous serving carrier RSSI measurement is related to at least one of: the measurement gap (MG) for FC RMTC measurement, the number of measurable measurement objects between operators when the MG is not required, the configured total number of inter-frequency frequency layers, and the carrier specific scaling factor for non-contiguous serving carrier measurement.

Optionally, the detection period for non-contiguous serving carrier RRM detection is related to at least one of: the number of SSB occasions unavailable at the UE due to in-gap interference measurement, the carrier specific scaling factor for non-contiguous serving carrier measurement, and the scaling factor in the situation where the SMTC of interference CCs is overlapped with the measurement gap.

Optionally, the evaluation period for non-contiguous serving carrier out-of-sync and in-sync RLM evaluation is related to at least one of: the number of SSB occasions unavailable at the UE due to in-gap interference measurement in the out-of-sync and in-sync situations, and RLM-RS SSB SINR/SNR.

In the extended measurement time, invalid SSB samples should not be taken into consideration; otherwise, the accuracy of results will be affected.

Optionally, the number of SSB occasions unavailable at the UE due to in-gap interference measurement in all measurements is related to at least one of: the configured DRX cycle, MG period, SMTC period, or the like.

At operations 1707, 1708, 1709, 1710, and 1711, the UE performs switching between a fully shared Rx chain and a separate Rx chain according to conditions. The conditions are the above switching conditions 1-4. If the switching condition is met (the power level of the interference source is obviously larger than the required signal), the UE falls back to a separate Rx chain to receive and measure non-contiguous CCs, and performs at least one of corresponding RRM measurement, cell detection, L1 measurement and RLM based on the predetermined delay requirement. Meanwhile, the NW determines the interference level of the given inter-operator carrier according to the reported interference measurement result. If the interference level is too high, the NW may update the CA configuration through the RRC reconfiguration to indicate to the UE that the number of CCs that may be aggregated decreases.

At operations 1712 and 1713, for a UE that supports the use of a fully shared Rx chain to receive non-contiguous serving carriers, after the fully shared Rx chain structure is switched to a fully shared Rx chain structure and if the NW sends new BS signaling through RRC to indicate whether there is a non-contiguous serving carrier operation driven by the scenario or requirement or according to the operator requirement or data traffic, the network performs the CA configuration again to indicate to the UE that there are more CCs to be aggregated. If the condition of using a fully shared Rx chain is met, the UE may use the fully shared Rx chain to process non-contiguous CCs.

It should be noted that:
1) A switching delay is required for switching between a fully shared Rx chain and a separate Rx chain structure. This time may include an RF hardware preparation time. Moreover, considering the switching time and/or the RRC reconfiguration signaling processing time, the measurement of wanted CCs will be interrupted.
2) For a UE the supports the new capability, in a non-contiguous serving carriers scenario, a fully shared Rx chain is used by default.
3) The accuracy of all the measured SS-RSRP and L1-RSRP need to meet the corresponding defined accuracy requirements.
4) The UE and the NW cooperate. That is, if the interference level measured by the UE is too high, the UE needs to switch from a fully shared Rx chain structure to a separate Rx chain structure. The network uses less CCs for RRC reconfiguration according to the measurement result.

An embodiment of the disclosure provides a method performed by a network node in a communication system, comprising:
sending measurement configuration information to a user equipment (UE), the measurement configuration information including information related to measurements of a first carrier, a second carrier, and a third carrier; and
receiving a first measurement result and a second measurement result, the first measurement result being obtained by measuring the first carrier and the second carrier based on the measurement configuration information by the UE, the second measurement result being obtained by measuring the third carrier based on a measurement period by the UE, the measurement period being determined based on the first measurement result by the UE.

Optionally, the first carrier and the second carrier are non-contiguous carriers.

Optionally, the UE supports a first capability that includes a capability of using a first receiving mode to receive the first carrier and the second carrier.

Optionally, the measurement period for the third carrier is determined in at least one of the following ways:
when the first measurement result is larger than a first threshold, a first measurement period for the third carrier is determined based on a first scaling factor;
when the first measurement result is smaller than a second threshold, a second measurement period for the third carrier is determined based on at least one of an interference received signal strength indication (RSSI) measurement timing configuration (RMTC) period, a discontinuous reception (DRX) cycle, a measurement in-gap carrier-specific scaling factor (CSSF) and a measurement gap period, wherein the second measurement period is related to RSSI measurements;
when the first measurement result is smaller than the second threshold, a third measurement period for the third carrier is determined based on at least one of a period of reference signals transmitted on downlink carriers in different bands and the number of samples required for reference signal received power (RSRP) measurement of the third carrier in different bands; and
when the first measurement result is smaller than the second threshold, a fourth measurement period for the third carrier is determined based on at least one of the total number of samples to be measured, a period of reference signals transmitted on the third carrier, a second scaling factor related to Layer 1 and/or Layer 3 measurements and a measurement period lower bound related to UE capabilities,
wherein the first scaling factor and the second scaling factor are measurement relaxation factors.

Optionally, the RSRP measurement of the third carrier is performed in a measurement window, and the measurement window is determined based on the fourth measurement period and a measurement result reporting configuration period.

Optionally, the method may further include:
receiving the normalized measurement result, where the measurement result of measuring the third carrier based on the second measurement period is normalized according to at least one of: a default measurement bandwidth for measurement, and the number of frequency-domain units.

Optionally, the CSSF is determined based on at least one of:
the number of searchers related to band combinations of the first carrier and the second carrier;
the proportion of resources occupied by each measured component carrier in the searchers; and
the priority of each measured component carrier.

Optionally, when measuring the third carrier based on the first measurement period, SSB-less based measurement or SSB based measurement is performed for a secondary component carrier in the first carrier and the second carrier.

Optionally, the method may further include:
determining a fifth measurement period for measurement of the first carrier and the second carrier based on the number of reference signal occasions unavailable for measurement in the measurement period, when the first measurement result is smaller than a second threshold,
wherein the number of reference signal occasions unavailable for measurement in the measurement period may include at least one of the number of synchronization signal block (SSB) measurement timing configuration (SMTC) occasions unavailable for synchronization signal measurement in the measurement period and the number of SSB occasions unavailable for Layer 1 measurement in the measurement period.

Optionally, the number of reference signal occasions unavailable for measurement is related to at least one of: a discontinuous reception (DRX) cycle and a reference signal period.

Optionally, the switching condition is related to at least one of:
first carrier aggregation reconfiguration information being received; and
the first measurement result being smaller than a third threshold in a first evaluation duration, and the second measurement result of measuring the third carrier being larger than a fourth threshold in a second evaluation duration,
wherein the first evaluation duration and the second evaluation duration are values configured by a network node or predefined.

Optionally, when the RSRP measurement results of the first carrier and the second carrier are smaller than the third threshold in the first evaluation, the third threshold is related to an RSRP threshold; and
when the downlink received signal to interference plus noise ratio (SINR) performance of the first carrier and the second carrier is smaller than the third threshold in the first evaluation duration, the third threshold is related to a radio link monitor out-of-sync threshold.

Optionally, the method may further include:
receiving UAI sent by the UE, the UAI being used for at least requesting the network node to reconfigure carrier aggregation; and
sending second carrier aggregation reconfiguration information to the UE to indicate the UE to switch from the first receiving mode to the second receiving mode to receive the first carrier and the second carrier.

Optionally, after the UE switches to the second receiving mode, the method may further include:
sending third carrier aggregation reconfiguration information to the UE to indicate the UE to switch from the second receiving mode to the first receiving mode to receive the first carrier and the second carrier.

Optionally, the method may further include:
receiving information related to the first capability reported by the UE.

Optionally, the information related to the first capability may include at least one of:
an RF requirement related to band combinations of the first carrier and the second carrier;
a radio resource management (RRM) requirement related to band combinations of the first carrier and the second carrier; and
information related to a frequency span of the first carrier and the second carrier.

The steps/operations of the method performed by a network node provided in the embodiments of the disclosure correspond to those of the method performed by a UE, and the both have similar implementation principles and corresponding technical effects. The detailed functional description of the method performed by a network node may specifically refer to the above description of the method performed by a UE and will not be repeated here.

An embodiment of the disclosure provides an electronic device, including a processor, and optionally a transceiver and/or memory coupled to the processor, wherein the processor is configured to perform the steps/operations of the method provided in any one of the optional embodiments of the disclosure. Optionally, if the electronic device may be a UE, the processor is configured to implement the steps/operations in the embodiments of the method performed by a UE. The detailed functional description and the achieved beneficial effects may specifically refer to the above description of the embodiments of the method performed by a UE and will not be repeated here. Optionally, the electronic device may be a network node, and the processor is configured to implement the steps/operations in the embodiments of the method performed by a network node. The detailed functional description and the achieved beneficial effects may specifically refer to the above description of the embodiments of the method performed by a network node and will not be repeated here.

An embodiment of the disclosure further provides an electronic device, including at least one controller/processor, and optionally at least one transceiver coupled to the at least one controller/processor. The processor is configured to implement the method provided in any one of optional embodiments of the disclosure.

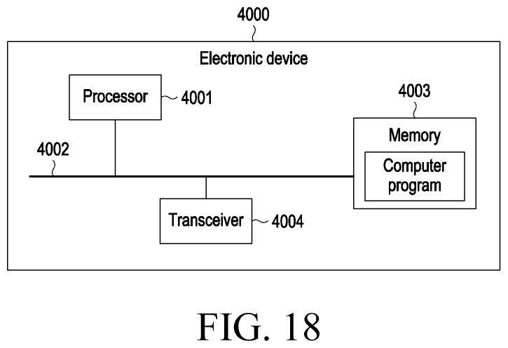

FIG. 18 shows a schematic structure diagram of an electronic device to which the solution of the embodiment of the disclosure is applied according to an embodiment of the disclosure.

Referring to FIG. 18, the electronic device 4000 may include a processor 4001 and memory 4003. The processor 4001 is connected to the memory 4003, for example, through a bus 4002. Optionally, the electronic device 4000 may further include a transceiver 4004 that may be used for data exchange, for example, transmission and reception of data, between the electronic device and other electronic device. It should be noted that, in practical applications, the number of transceiver 4004 is not limited to one, and the structure of the electronic device 4000 does not constitute any limitations to the embodiments of the disclosure. Optionally, the electronic device may be gNB, UE or other entities or node in communication networks.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various logical blocks, modules and circuits described in connection with the disclosure. The processor 4001 may also be a combination for realizing computing functions, for example, a combination of one or more microprocessors, a combination of a DSP and a microprocessor, or the like.

The bus 4002 may include a path to transfer information between the components described above. The bus 4002 may be a peripheral component interconnect (PCI) bus, or an extended industry standard architecture (EISA) bus, or the like. The bus 4002 may be an address bus, a data bus, a control bus, or the like. For ease of presentation, the bus is represented by one thick line in FIG. 18. However, it does not mean that there is one bus or one type of buses.

The memory 4003 may be, but not limited to, read only memories (ROMs) or other types of static storage devices that may store static information and instructions, random access memories (RAMs) or other types of dynamic storage devices that may store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, or the like.), magnetic storage media or other magnetic storage devices, or any other media that may carry or store desired program codes in the form of instructions or data structures and that may be accessed by computers.

The memory 4003 is used to store computer program for executing the solutions of the disclosure, and is controlled by the processor 4001. The processor 4001 is used to execute the computer program stored in the memory 4003 to implement the solution provided in any method embodiment described above.

Embodiments provide a computer-readable storage medium having a computer program stored on the computer-readable storage medium, the computer program, when executed by a processor, implements the steps/operations and corresponding contents of the foregoing method embodiments.

Embodiments of the disclosure also provide a computer program product including a computer program, the computer program when executed by a processor realizing the steps/operations and corresponding contents of the preceding method embodiments.

The terms “first”, “second”, “third”, “fourth”, “1”, “2”, or the like. (if present) in the specification and claims of this disclosure and the accompanying drawings above are used to distinguish similar objects and need not be used to describe a particular order or sequence. It should be understood that the data so used is interchangeable where appropriate so that embodiments described herein can be implemented in an order other than that illustrated or described in the text.

It should be understood that while the flow diagrams of embodiments of the disclosure indicate the individual operational steps/operations by arrows, the order in which these steps/operations are performed is not limited to the order indicated by the arrows. Unless explicitly stated herein, in some implementation scenarios of embodiments of the disclosure, the implementation steps/operations in the respective flowcharts may be performed in other orders as desired. In addition, some, or all of the steps/operations in each flowchart may include multiple sub-steps/sub-operations or multiple phases based on the actual implementation scenario. Some or all of these sub-steps/sub-operations or stages can be executed at the same moment, and each of these sub-steps/sub-operations or stages can also be executed at different moments separately. The order of execution of these sub-steps/sub-operations or stages can be flexibly configured according to requirements in different scenarios of execution time, and the embodiments of the disclosure are not limited thereto.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving measurement configuration information, the measurement configuration information comprising information related to measurements of a first carrier, a second carrier, and a third carrier;
obtaining a first measurement result by measuring the first carrier and the second carrier based on the measurement configuration information, and determining a measurement period for the third carrier based on the first measurement result; and
obtaining a second measurement result by measuring the third carrier based on the measurement period.

2. The method of claim 1, wherein the first carrier and the second carrier are non-contiguous carriers.

3. The method of claim 1,
wherein the UE supports a first capability that comprises a capability of using a first receiving mode to receive the first carrier and the second carrier, and
wherein the method further comprises:
determining, based on at least one of the first measurement result, the second measurement result and a switching condition, whether to switch from the first receiving mode to a second receiving mode to receive the first carrier and the second carrier, or whether to use the first receiving mode to receive a primary component carrier in the first carrier and the second carrier.

4. The method of claim 1, wherein the determining of the measurement period for the third carrier, comprises at least one of:
determining a first measurement period for the third carrier based on a first scaling factor, wherein the first measurement result is larger than a first threshold;
determining a second measurement period for the third carrier based on at least one of an interference received signal strength indication (RSSI) measurement timing configuration (RMTC) period, a discontinuous reception (DRX) cycle, a measurement in-gap carrier specific scaling factor (CSSF) and a measurement gap period of the third carrier, wherein the first measurement result is smaller than a second threshold, and the second measurement period is related to RSSI measurements;
determining a third measurement period for the third carrier based on at least one of a period of reference signals transmitted on downlink carriers in different bands and a number of samples required for reference signal received power (RSRP) measurement of the third carrier in different bands, wherein the first measurement result is smaller than the second threshold; and
determining a fourth measurement period for the third carrier based on at least one of a total number of samples to be measured, a period of reference signals transmitted on the third carrier, a second scaling factor related to layer 1 and/or layer 3 measurements and a measurement period lower bound related to UE capabilities, wherein the first measurement result is smaller than the second threshold,
wherein the first scaling factor and the second scaling factor are measurement relaxation factors.

5. The method of claim 4, wherein the measuring of the third carrier based on the fourth measurement period comprises:
determining a measurement window based on the fourth measurement period and a measurement result reporting configuration period, and performing the RSRP measurement on the third carrier in the measurement window.

6. The method of claim 4, further comprising:
normalizing the second measurement result of the measuring of the third carrier based on the second measurement period, based on at least one of: a default measurement bandwidth used for measurement, or a number of frequency-domain units; and
reporting the normalized second measurement result.

7. The method of claim 4, wherein the CSSF is determined based on at least one of:
a number of searchers related to band combinations of the first carrier and the second carrier,
a proportion of resources occupied by each measured component carrier in the searchers, or
a priority of each measured component carrier.

8. The method of claim 4, further comprises:
performing a synchronization signal block (SSB)-less based measurement or an SSB based measurement for a secondary component carrier in the first carrier and the second carrier,
wherein the measuring of the third carrier is based on the first measurement period.

9. The method of claim 1, further comprising:
determining a fifth measurement period for measurement of the first carrier and the second carrier based on a number of reference signal occasions unavailable for measurement in the measurement period, when the first measurement result is smaller than a second threshold,
wherein the number of reference signal occasions unavailable for measurement in the measurement period comprises at least one of a number of synchronization signal block (SSB) measurement timing configuration (SMTC) occasions unavailable for synchronization signal measurement in the measurement period and the number of SSB occasions unavailable for Layer 1 measurement in the measurement period.

10. The method of claim 9, wherein the number of reference signal occasions unavailable for measurement is related to at least one of: a discontinuous reception (DRX) cycle and a reference signal period.

11. The method of claim 3,
wherein the switching condition is related to at least one of:
first carrier aggregation reconfiguration information being received, or
the first measurement result being smaller than a third threshold in a first evaluation duration, and the second measurement result of measuring the third carrier being larger than a fourth threshold in a second evaluation duration.

12. The method of claim 11,
wherein, reference signal received power (RSRP) measurement results of the first carrier and the second carrier are smaller than the third threshold in the first evaluation duration, and the third threshold is related to an RSRP threshold, and
wherein, a downlink received signal to interference plus noise ratio (SINR) performance of the first carrier and the second carrier is smaller than the third threshold in the first evaluation duration, and the third threshold is related to a radio link monitor out-of-sync threshold.

13. The method of claim 3, further comprising:
switching from the first receiving mode to the second receiving mode after a first interruption length, wherein the switching condition is met.

14. The method of claim 3, further comprising:
sending, to a network node, UE assistance information (UAI) used for at least requesting the network node to reconfigure carrier aggregation;
receiving second carrier aggregation reconfiguration information from the network node; and
switching, based on the second carrier aggregation reconfiguration information, from the first receiving mode to the second receiving mode.

15. The method of claim 14, wherein, after the switching to the second receiving mode, the method further comprises:
receiving third carrier aggregation reconfiguration information; and
switching, based on the third carrier aggregation reconfiguration information, from the second receiving mode to the first receiving mode.

16. The method of claim 3, further comprising:
reporting, to a network node, information related to the first capability.

17. The method of claim 16, wherein the information related to the first capability comprises at least one of:
an radio frequency (RF) requirement related to band combinations of the first carrier and the second carrier,
a radio resource management (RRM) requirement related to band combinations of the first carrier and the second carrier, or
information related to a frequency span of the first carrier and the second carrier.

18. A method performed by a network node in a communication system, the method comprising:
sending measurement configuration information to a user equipment (UE), the measurement configuration information comprising information related to measurements of a first carrier, a second carrier, and a third carrier; and
receiving a first measurement result and a second measurement result, the first measurement result being obtained by measuring the first carrier and the second carrier based on the measurement configuration information by the UE, the second measurement result being obtained by measuring the third carrier based on a measurement period for the third carrier by the UE, the measurement period being determined based on the first measurement result by the UE.

19. A user equipment (UE) in a communication system, comprising:
a transceiver;
memory, comprising one or more storage media, storing instructions; and
at least one processor communicatively coupled to the transceiver and the memory,
wherein the instructions, when executed by the at least one processor individually or collectively, cause the UE to:
receive measurement configuration information, the measurement configuration information comprising information related to measurements of a first carrier, a second carrier, and a third carrier,
obtain a first measurement result by measure the first carrier and the second carrier based on the measurement configuration information, and determine a measurement period for the third carrier based on the first measurement result, and
obtain a second measurement result by measure the third carrier based on the measurement period.

20. The UE of claim 19,
wherein the measurement period for the third carrier is an in-gap measurement of the third carrier, and
wherein the measurement period for the third carrier is based on a first scaling factor.
